(19) United States
(12) Patent Application Publication
(10) Pub. No.: US 2023/0019550 A1
(43) Pub. Date: Jan. 19, 2023

(54) TECHNIQUE FOR MARKING A PROLATE OBJECT

(71) Applicant: Phoenix Contact GmbH & Co. KG, Blomberg (DE)

(72) Inventors: Kilian Klages, Detmold (DE); Alexander Hofmann, Hameln (DE); Jonas Korsmeier, Lemgo (DE); Markus Traenkle, Dauchingen (DE); Juergen Gretscher, Dornhan (DE); Benjamin Aberle, Dunningen (DE); Dan King, VS-Rietheim (DE)

(21) Appl. No.: 17/765,450

(22) PCT Filed: Oct. 6, 2020
(86) PCT No.: PCT/EP2020/077960

§ 371 Date: Sep. 27, 2022

(30) Foreign Application Priority Data
Oct. 9, 2019 (BE) BE2019/5663

(51) Int. Cl. B41J 3/407; B41J 3/44

(52) U.S. Cl. CPC B41J 3/40733; B41J 3/445

(57) ABSTRACT

A device (100) for providing a tube arranged or arrangeable in a circumferentially closed manner around a prolate object (102), preferably around a conductor, as a marking (101) of the object (102) is described. The device (100) comprises a printer (200) for outputting a printed tube (214) in longitudinal direction (210) or a material interface (156) for receiving a printed tube (214) output from a printer (200) in longitudinal direction (210). Further, the device (100) comprises a cutting unit (120) configured to cut through the printed tube (214) at a cutting position of the tube (214) in a transverse direction (121) transverse, preferably perpendicular, to the longitudinal direction (210) of the tube. At least at the intersection, an upper half of the tube and a lower half of the tube, terminally or insidely, abut on each other or are connected to each other. Further, the device (100) comprises an opening unit (122) for opening the upper and lower halves of the tube. The opening unit comprises at least two opening rollers (123), each rotatable about a rotational axis (123A). The respective rotational axis (123A) is perpendicular or substantially perpendicular to the longitudinal direction (210) and the transverse direction (121). The at least two opening rollers (123) abut against the cut and printed tube on opposite sides in the transverse direction (121).

### CROSS-REFERENCE TO PRIOR APPLICATIONS

This application is a U.S. National Phase Application under 35 U.S.C. § 371 of International Application No. PCT/EP2020/077960, filed on Oct. 6, 2020, and claims benefit to Belgian Patent Application No. BE 2019/5663, filed on Oct. 9, 2019. The International Application was published in German on Apr. 15, 2021 as WO/2021/069416 under PCT Article 21(2).

### FIELD

The invention relates to a technique for marking a prolate object, for example a conductor. In particular, the invention relates to a device for providing a marking that is arranged or arrangeable in a closed manner around a prolate object.

### BACKGROUND

For marking electrical conductors as an example, label printers are conventionally used for printing a label, which then has to be manually mounted on the conductor after the printing. The document U.S. 2003/146943 A1 describes a printer that alternately prints and cuts such a label.

Furthermore, special printers are known which may be used for conductor labeling. The document U.S. 2004/0211522 A1 describes a machine for winding around a conductor a pre-printed wrap-around label from a spindle roll. The document U.S. 2008/0073023 A1 describes a monolithic machine for printing and applying wrap-around labels.

However, conventional devices are capable of printing only certain labels and, if an automated application of the label is integrated into the device, no other printing applications are possible with such a device.

The document WO 1999/56271 A1 describes the opening of a printed shrink tube in order to push it onto a conductor. However, in the conventional technique for opening, it is well possible that the tube does not open when pressed by means of jaws on the longitudinal edges of the flattened tube, rather an upper and a lower half of the tube buckle in the same direction.

### SUMMARY

In an embodiment, the present invention provides a device for providing a tube arranged or arrangeable in a circumferentially closed manner around a prolate object, as a marking of the object, the device comprising: a printer configured to output a printed tube in a longitudinal direction or a material interface configured to receive a printed tube output from a printer in the longitudinal direction; a cutting unit configured to cut through the printed tube at a cutting position of the tube in a transverse direction transverse to the longitudinal direction of the tube, at least at the cutting position an upper half of the tube and a lower half of the tube, at an end and/or on an inside, abut each other or are connected to each other; and an opening unit configured to open upper and lower halves of the tube, the opening unit comprising at least two opening rollers each rotatable about a rotational axis, a respective rotational axis being perpendicular or substantially perpendicular to the longitudinal direction and to the transverse direction, wherein the at least two opening rollers abut against the cut and printed tube on opposite sides in the transverse direction or each is configured to drive a belt abutting against the cut and printed tube on opposite sides in the transverse direction.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a schematic sectional view of a first embodiment of a device for providing a tube as a marking mounted to an embodiment of a printer;

FIG. 2 a schematic sectional view of a second embodiment of the device for providing a tube as a marking in a first state;

FIG. 3 a schematic sectional view of the second embodiment of the device for providing a tube as a marking in a second state;

FIG. 4 a schematic top view of a third embodiment of the device for providing a tube for marking;

FIG. 5A a schematic perspective view of an exemplary opening unit usable in embodiments of the device;

FIG. 5B a schematic view of a first exemplary object centering unit usable in embodiments of the device;

FIG. 5C a schematic view of a second exemplary object centering unit usable in embodiments of the device;

FIG. 6A a schematic perspective view of an exemplary cutting unit of the device for providing a tube as a marking;

FIG. 6B a schematic perspective view of a variant of the cutting unit of FIG. 6A;

FIG. 6C a schematic view of a first exemplary combination of blades for the cutting unit of the device for providing a tube as marking;

FIG. 6D a schematic view of a second exemplary combination of blades for the cutting unit of the device for providing a tube as marking;

FIG. 6E a schematic view of a third exemplary combination of blades for the cutting unit of the device for providing a tube for marking;

FIG. 7A a schematic perspective view of an exemplary holding-flat unit of the device for providing a tube as a marking, preferably with heating elements acting on the tube perpendicular to the transverse direction;

FIG. 7B a schematic top view of an exemplary opening unit of the device for providing a tube as a marking, preferably with two heating elements acting on the tube and being opposite to each other in the transverse direction;

FIG. 8A a schematic top view of an exemplary roller pair arrangement of the printer and/or device for providing a tube for marking;

FIG. 8B a schematic perspective view of the exemplary roller pair arrangement of FIG. 8A;

FIG. 9 a schematic sectional view of an embodiment of the printer as a thermal transfer printer;

FIG. 10A a schematic perspective view of an exemplary printing system, comprising an embodiment of the printer and an embodiment of the device for providing a tube as a marking, in a mounted position;

FIG. 10B a schematic perspective view of the exemplary printing system of FIG. 10A in a disassembled position;

FIG. 11A a first flowchart of an embodiment of a method for providing a tube as a marking; and

FIG. 11B a second flowchart of an embodiment of a method for providing a tube as a marking;

### DETAILED DESCRIPTION

In an embodiment, the present invention provides a device for a printing system, preferably with the size and portability of a desk-top device, so that the system may be quickly converted to various applications of object marking, preferably various applications of conductor marking, including marking with a printed tube (or sleeve). Additionally, the printed tube may be reliably opened.

An aspect relates to a device for providing a tube (or sleeve) arranged or arrangeable in a closed circumferential manner around a prolate object, preferably a conductor, as a marking of the object. The device comprises a printer configured to output a printed tube (or sleeve) in a longitudinal direction, or a material interface configured to receive a printed tube output from a printer in a longitudinal direction. Alternatively or additionally, the device comprises a cutting unit configured to cut through the printed tube at a cutting position of the tube in a transverse direction that is transverse, preferably perpendicular, to the longitudinal direction of the tube, wherein at least at the cutting position an upper half of the tube and a lower half of the tube abut on each other or are connected to each other at the end (or terminally) and/or on the inside (or insidely). Alternatively or additionally, the device comprises an opening unit for opening the upper and lower halves of the tube, which comprises at least two opening rollers rotatable about a rotational axis in each case, the respective rotational axis being perpendicular or substantially perpendicular to the longitudinal direction and to the transverse direction, and the at least two opening rollers abutting against the cut and printed tube on sides opposite (or opposing) in the transverse direction or driving in each case a belt abutting against the cut and printed tube on sides opposite (or opposing) in the transverse direction.

The opening unit may be configured to separate the upper half of the tube and the lower half of the tube from each other and/or to open the cut and printed tube, for example terminally at the cut or continuously along the longitudinal direction. For example, the opening rollers may be used to detach the upper half of the tube from the lower half.

The opening rollers may open the printed tube, for example in a flattened state of the tube (i.e., pressed flat or kept flat), by flexing the tube. The tube may be opened starting from a flat state by applying the opening rollers at isolated locations (i.e., in a punctiform manner) to the longitudinal edge of the tube or in a linear manner (for example, by means of a belt running over the opening rollers).

The opening rollers may be arranged (or positioned) in pairs against the cut and printed tube at locations (or points) perpendicular to the longitudinal direction.

The device may further comprise an object centering unit configured to arrange the prolate object, preferably the conductor, in alignment or coaxially with the cut and printed tube.

The opening rollers may be configured to push the cut and printed tube along the longitudinal direction over or onto the prolate object for the arrangement circumferentially closed around the prolate object.

The device may further comprise a printing signal interface configured to capture (or detect or receive) a control signal as to the output of the printed tube. Alternatively or additionally, the device may comprise at least one sensor configured to capture (or detect or receive) a control signal for the providing of the marking.

The device may further comprise a roller drive configured to synchronously rotate the opening rollers about the respective rotational axis (and, if necessary, to drive the belts with it). The opening rollers, which abut against the cut and printed tube on opposite sides in the transverse direction, may rotate in opposite directions.

The roller drive may be configured to arrange the marking on the object in a circumferentially closed manner or to provide it for circumferentially closed arrangement, depending on the control signal for the outputting of the printed tube and/or the control signal for the providing of the marking.

The device may further comprise two carriages longitudinally movable in the transverse direction, on each of which at least one of the at least two opening rollers is rotatably mounted about the respective rotational axis. A distance between the two opening rollers of the respective pair of rollers and/or a pressure force of the opening rollers on the cut and printed tube may depend on a detected or measured width of the tube.

The device may further comprise a width sensor arranged between the holding-flat unit and the opening unit or between pairs of rollers of the opening unit, which is configured to measure the width of the tube (preferably before opening and/or during opening). Alternatively or additionally, the width of the tube may be acquired (or detected) via the data interface.

The circumferentially closed surface of the cut and printed tube as the marking may be simply-connected. For example, the circumferentially closed arrangement may comprise openings in the surface.

The device may be a device for providing a printed tube or for applying a printed tube to the prolate object (in short: applicator). Alternatively or additionally, the device may be a device for circumferentially arranging a printed marking around a prolate object, preferably around a conductor.

A longitudinal direction (also: direction of movement or motion) of the tube as the printing medium may correspond to the feeding direction (also: direction of conveyance or transport) of the printer and/or the device.

The opening rollers may abut against the cut and printed tube at longitudinal edges opposite in the transverse direction. The longitudinal edges may be closed (or folded) edges of the cut and printed tube in the transverse direction.

In a first variation applicable to each feature and embodiment, the device may be configured as an applicator, stem, or attachment of the printer, particularly a thermal transfer printer. The device may be interchangeable. A plurality of different embodiments of the devices may optionally each be attachable to the same printer.

In a second variation applicable to each feature and embodiment, the device may comprise the printer.

A printing medium of the printer may be a tube. A length of the tube as a printing medium may be any length or several times longer than the provided printed tube as a marking. The printing medium may be referred to as an endless tube. The printed tube that is output from the printer may also be referred to as a printed product. The printed product from the printer may comprise the printed tube. The (printed) marking may comprise the cut and opened printed tube.

The printer may receive an identifier via an interface (e.g., a network interface or a serial interface). The printer may be configured to print the received identifier onto a print medium using a printing material. The printing material may comprise a color ribbon, such as for thermal transfer printing. The printing medium (i.e., a printing substrate or label material) may be a plastic film, for example for heat sealing or welding, or a heat shrink tube. The printed product may comprise the printed medium printed by means of the printing material.

The providing may comprise arranging the marking on the prolate object, preferably arranging the marking circumferentially about a longitudinal axis of the prolate object. The at least one actuator may be configured to circumferentially arrange the printed marking about a longitudinal axis of the object.

For example, the opening unit may arrange or provide the marking when the control signal of the printing signal interface indicates the output of the printed product at the material interface and the control signal of the sensor indicates the presence of the object or a user request to provide the marking.

The device and the printer may be arranged side by side, for example without a direct mechanical connection. For example, the printer and device may each be arranged in a stationary and/or slip-proof manner on the same work surface. For example, a material interface of the printer may be aligned with, or may overlap with, the material interface of the device. There may be a clear gap between the printer and the device during operation.

The cutting unit may comprise a movable blade (preferably a longitudinally movable blade) which, for example, stands vertically and moves up in a controlled manner for cutting. The movable blade may slide over a stationary counter blade (or briefly: stationary blade). A through opening of the material interface may be arranged or formed between the blades, i.e. the printed tube may be transferred to the device between the blades.

A drive for the blade may be arranged below the material interface and/or may comprise an electric motor, a gearbox and a rack (e.g., for rack and pinion) mounted on the movable blade as a linear drive.

A cutting edge of the movable blade may be oblique (or non-perpendicular) to the direction of motion or may be V-shaped. A cutting edge of the stationary blade may be perpendicular to the direction of motion or V-shaped. The movable blade having an oblique cutting edge may comprise a guide pin that engages the stationary blade in an open position of the movable blade.

The device may further comprise a holding-flat unit configured to prevent buckling of the tube perpendicular to the longitudinal direction and/or perpendicular to the transverse direction. For example, the holding-flat unit may comprise two holding-down edges between which the tube may be selectively or controllably held flat or guided.

The holding-flat unit and the cutting unit may be driven by a common drive.

The holding-flat unit may be configured to prevent downward buckling of the upper half of the tube downward and/or to prevent upward buckling of the lower half of the tube.

The holding-flat unit or an additional unit of the device may comprise a heating element between the holding-flat unit and the opening unit. The heating element may be configured to heat the tube on one side, preferably either the upper half of the tube or the lower half of the tube, for local deformation of the tube, preferably for local contraction of the tube (for example, a shrink tube).

Alternatively or additionally, the heating elements may be arranged on both sides of the tube in the transverse direction. For example, the opening unit or an additional unit between the holding-flat unit and the opening unit comprises two heating elements that press on the tube and/or conduct heat on opposite sides of the tube in the transverse direction.

The printed tube may be guided by the holding-flat unit, in particular between two horizontal surfaces, a horizontal surface and a roller with a horizontal running surface, or two rollers with horizontal running surfaces. A distance in the longitudinal direction of the tube between (for example, the horizontal guide) the holding-flat unit and a first opening roller of the opening unit (for example, to apply an edge pressure) may be smaller than a width or a diameter of the tube.

The opening unit may abut directly against opposite edges (i.e. longitudinal edges) of the flat (i.e. still closed) tube or may drive at least two belts abutting against opposite edges on the tube. The opening rollers may apply (directly or via the belt) a horizontal compressive force to the respective edge of the tube. The opening rollers may be biased in the direction of the tube. Opening rollers may have a vertical rotational axis.

The opening rollers or the belts may be waisted. The opening rollers (and, if necessary, the belts with them) may be driven in the direction of movement of the tube.

Preferably, a plurality of opening rollers are arranged in pairs opposite each other on each side of the tube. The plurality of opening rollers may be driven synchronously.

The opening rollers (and, where appropriate, belts) may be mounted on carriages movable transversely to the longitudinal direction of the tube. A distance between the rollers or belts may be controlled by means of the movable carriages, for example as a function of the width or diameter of the tube. The width sensor may detect the width or diameter of the tube without contact, preferably optically.

The device may further comprise a reduced pressure opening unit (or vacuum opening unit) comprising at least one suction cup, preferably at least two suction cups. The suction cup or cups may each be brought into contact with the upper half of the tube and/or the lower half of the tube. By means of a reduced pressure in the respective suction cup, the vacuum opening unit is capable of at least partially separating (or releasing or detaching) the upper half of the tube and the lower half of the tube from one another when the tube is opened.

Opening the tube may open the tube non-destructively. The upper half of the tube and the lower half of the tube may be connected at the longitudinal edge of the tube and remain connected.

The vacuum opening unit may be part of the opening unit, may be part of the holding-flat unit, or may be arranged between the holding-flat unit and the opening unit.

The reduced pressure (for example, a reduced or so-called negative air pressure or underpressure) in the suction cups may be exerted transversely to the pressure force of the opening rollers and/or transversely to the direction of movement or the longitudinal direction (preferably in opposite directions on the upper and lower halves of the tube). Optionally, an excess air pressure (for example, an increased air pressure or overpressure) is applied to the end of the tube, preferably by means of a nozzle, parallel to the direction of movement or longitudinal direction.

The device may further comprise a mechanical interface configured to releasably or irreversibly attach (or mount) the device to the printer. The attachment (or mounting) may be irreversible, for example, may comprise a material-locking connection. Alternatively, the device may be removably attached (or mounted) to the printer, for example, may be non-destructively detachable (or releasable), and/or may be attachable (or can be mounted) and/or detachable (or releasable) without tools.

The at least one sensor of the control signal for providing the marking may be configured to detect the object, preferably to detect a presence, a location, and/or a size of the object.

The control signal for providing the marking may indicate the presence (i.e., the presence), the location, and/or the size of the object. The location may comprise a position and/or orientation of the object (for example, a longitudinal axis of the object). The size may comprise a length (for example, along the longitudinal axis), a diameter, and/or a circumference of the object.

The at least one sensor of the control signal for providing the marking may detect the object without contact.

The at least one sensor of the control signal for providing the marking may comprise a push button. The control signal for providing the marking may indicate an actuation of the button.

The control signal for providing the marking may indicate a user request for providing the marking. The control signal for providing the marking may be a triggering signal.

The device comprises at least one actuator, wherein any one of the cutting unit, the opening unit, a holding-flat unit, a heating element, and/or a vacuum opening unit is an example of the at least one actuator of the device.

The at least one actuator may be configured to arrange the marking on the object in a circumferentially closed manner or to provide the marking for circumferentially closed arrangement in response to detecting the object and/or detecting the trigger signal.

The button may be a foot switch or a hand switch.

The printing signal interface may comprise a sensor configured to detect the printed product that is output by the printer, preferably to detect a presence, a position, and/or a feed of the output printed product.

The sensor for detecting the output of the printed product (also: sensor for detecting the output of the printed product or in short: sensor for detecting the printed product or printed product detection sensor) may be arranged at the material interface. The printed product detection sensor may detect the printed product without contact.

The at least one sensor may further comprise a sensor for detecting the printed product output from the printer. Detecting the printed product may comprise detecting a presence, a location (e.g., position and/or orientation), and/or a size (e.g., length and/or diameter) of the printed product.

The printing signal interface may comprise a data interface configured to communicate, preferably bidirectionally, with the printer for providing or arranging the marking.

The at least one actuator may be configured to (for example, in response to detecting the object and/or the trigger signal) process, in communication with the printer, the printed matter output by the printer for marking and arrange or provide the marking on the object for arrangement.

The bidirectional communication may comprise receiving the control signal for outputting the printed product from the printer and sending a control signal for requesting output of the printed product to the printer. For example, the control signal for providing the marking may be forwarded to the printer as a request for output of the printed product via the data interface.

The printer may be configured to deliver the printed product to the device at the material interface, for example, in accordance with bidirectional communication and/or in response to the control signal to provide the marking.

Alternatively or additionally, the data interface may be configured for wireless communication, preferably using radio signals, infrared signals, or near-field communication.

The data interface may be configured to synchronize or coordinate alternating and/or event-driven operation of the at least one actuator and the printer to provide or arrange the marking.

For example, a feed of the printed product executed by the printer may be alternately executed, synchronized and/or coordinated with a cutting, folding and/or turning of the output printed product. The respective substeps executed during alternating and/or event-driven operation by the device or by the printer for providing or arranging the marking may also be referred to as actions. The coordination of the substeps may also be referred to as action coordination.

The data interface may be configured to allow the printer to control the at least one actuator of the device, to read control signals from the at least one sensor and/or the printing signal interface of the device, and/or to read an identifier stored in the device.

The at least one actuator of the device may be controllable on the printer side by means of the data interface. Alternatively or additionally, measured values of the at least one sensor of the device may be queried by means of the data interface.

The data interface may be electrically connected within the device to the at least one actuator and/or the at least one sensor.

The data interface may be configured to receive control commands for controlling or regulating the at least one actuator from the printer and/or to send control commands for controlling or regulating the printer to the printer based on the control signals from the at least one sensor and/or the printing signal interface.

The data interface may be electrically connected to the at least one actuator and/or the at least one sensor within the device via a control unit and/or a regulating unit. The control unit and/or regulating unit may determine parameters of the applicator from the acquired (or received) measured values. The control commands sent to the printer may comprise the parameters and/or control the printer according to the parameters.

The data interface may be configured to send control signals from the at least one sensor and/or the printing signal interface and/or parameters determined from the control signals to the printer for providing or arranging the marking.

The device may further comprise a control unit or regulating unit configured to control or regulate the at least one actuator of the device depending on the control signals of the at least one sensor, measured values of the printer received via the data interface, confirmation messages of the printer received via the data interface, and/or control commands of the printer received via the data interface for arranging or providing the marking.

The control unit or regulating unit may be further configured to obtain a control command from the printer via the data interface, execute control or regulation of the at least one actuator in accordance with the control command, and send feedback to the printer via the data interface in response to completion of execution of the control command.

The feedback may comprise a confirmation of the (for example successful) completion of the execution of the control command or an error message regarding an error during the execution of the control command. For example, the feedback may inform the printer that a defined state of the device has been reached, such as an end position of the at least one actuator.

The control unit or regulating unit may be further configured to determine a parameter of the arranging based on the control signal detected by means of the at least one sensor, and to send the determined parameter to the printer via the data interface. The detected control signal may indicate a length, diameter, or circumference of the object. The determined parameter may indicate a length of a feed (e.g., an advance) or a retract of the printed product.

A control command sent from the device to the printer via the data interface may initiate a feed (e.g., an advance) or a retract.

The control unit or regulating unit may autonomously perform the providing or arranging of the marking, or a substep of providing or arranging the marking, in accordance with the control command during the period between obtaining the control command from the printer and sending the feedback to the printer.

The device may further comprise an electrical interface configured to supply electrical power to the device via the printer.

The data interface and/or the electrical interface may be arranged relative to the mechanical interface to contact the printer for communication or supply of electrical power when the device is attached (e.g., mounted) to the printer by means of the mechanical interface.

The data interface may be arranged relative to the mechanical interface to contact the printer for communication when the device is attached (e.g., mounted) to the printer by the mechanical interface. The electrical interface may be arranged relative to the mechanical interface to contact the printer for power when the device is attached to the printer by the mechanical interface. For example, attaching (or mounting or fastening) the device to the printer by means of the mechanical interface may cause contacts of the data interface and/or the electrical interface to become connected.

The object may comprise a conductor, preferably an electrical conductor or a light guide.

The mechanical interface may comprise a centering pin or an opening for receiving a centering pin and/or a lever and an eccentric connected to the lever in a rotationally fixed manner, which is configured for fastening the device to the printer without screws and/or without tools.

A further aspect relates to a system (also: printing system) for providing a tube arranged or arrangeable in a closed circumferential manner around a prolate object, preferably around a conductor, as a marking of the object. The system comprises a printer, preferably a thermal transfer printer, configured to output a printed tube as a printed product. Alternatively or additionally, the system comprises a device according to an embodiment of the device aspect. The material interface of the device may be arranged relative to the printer of the system, to receive the printed tube output by the printer as a printed product.

Another aspect relates to a method of providing a tube arranged or arrangeable in a closed circumferential manner around a prolate object, preferably a conductor, as a marking of the object. The method comprises a step of printing a tube in longitudinal direction or receiving a printed tube output at a material interface from a printer in longitudinal direction. Alternatively or additionally, the method comprises a step of cutting through the printed tube at a cutting position of the tube in a transverse direction, preferably perpendicular, to the longitudinal direction of the tube by means of a cutting unit. At least at the cutting position, an upper half of the tube and a lower half of the tube, at the end and/or on the inside (e.g., terminally and/or insidely), may abut on each other or be connected to each other. Alternatively or additionally, the method comprises a step of opening the upper and lower halves of the tube by means of an opening unit. At least two opening rollers, each rotatable about a rotational axis, may flex the tube, wherein the respective rotational axis is perpendicular or substantially perpendicular to the longitudinal direction and to the transverse direction, and wherein the at least two opening rollers abut against the cut and printed tube on opposite sides in the transverse direction or drive a respective belt abutting against the cut and printed tube on opposite sides in the transverse direction.

The method may further comprise any feature or corresponding method step disclosed in the context of the device, printer, and/or printing system. For example, the method may comprise at least one of the steps designated B1 to B17 and S1 to S24 in the description.

Embodiments of the device enable a modular system (also: printing system) that may be based on a single printer, for example a desk-top device, so that this printer may be converted in a short time or few steps to the different applications of object marking, preferably conductor marking. For example, a user may quickly and easily form a system from a normal or application-unspecific label printer for assisting in applying a marking (for example, a label) to the prolate object to be marked, preferably the conductor to be marked.

The terms application and applying may (preferably as a process step) be interpreted herein synonymously or interchangeably. The terms arranging and arranging may (preferably as a process step) be interpreted herein synonymously or interchangeably.

Applying the marking to the prolate object (preferably to the conductor) may comprise arranging the marking on the prolate object. Providing the marking arranged or arrangeable closed around the prolate object (preferably around the conductor) may comprise cutting (preferably trimming) the printed product.

The prolate object may be an elongated object. At least in sections, the prolate object may be a (for example general) cylinder, preferably a circular cylinder or a prism.

The prolate object may have a longitudinal axis. An extent of the object in the direction of the longitudinal axis may be greater (for example, several times greater) than one or any extent of the object transverse or perpendicular to the longitudinal axis.

The prolate object may be a conductor, a tube, a vessel, or a housing. The conductor may be an elongated object for conducting signals or substances. For example, the conductor may be an elongated object for conducting electrical current and/or electromagnetic radiation (preferably light). The vessel may be a test tube or a sample tube, for example for holding and/or transporting a fluid.

The conductor may comprise one core or two, at least two, three or more cores electrically insulated or optically decoupled from each other. The cores may run parallel to each other or be twisted together (for example in pairs).

The conductor may be a single, multi-stranded, fine-stranded and/or superfine-stranded conductor. The conductor may be a cable, cable bundle and/or ribbon cable. The conductor may be a light guide (also: light wave cable). The conductor may be a tube and/or a fluid line.

The conductor may be a cylindrical body and/or a non-rotationally symmetric elongated body. The conduction of the signals or substances may be directed along a longitudinal axis of the conductor and/or run between ends of the conductor.

By allowing embodiments of the device for a specific application to be attached to a printer that is not specific to the application, special printers for the respective application, and thus costs, may be avoided and/or resources may be used more effectively. For example, a utilization rate of the printer may be increased as a result. The same or further embodiments of the device may reduce a downstream manual effort in mounting the printing materials on the objects to be marked.

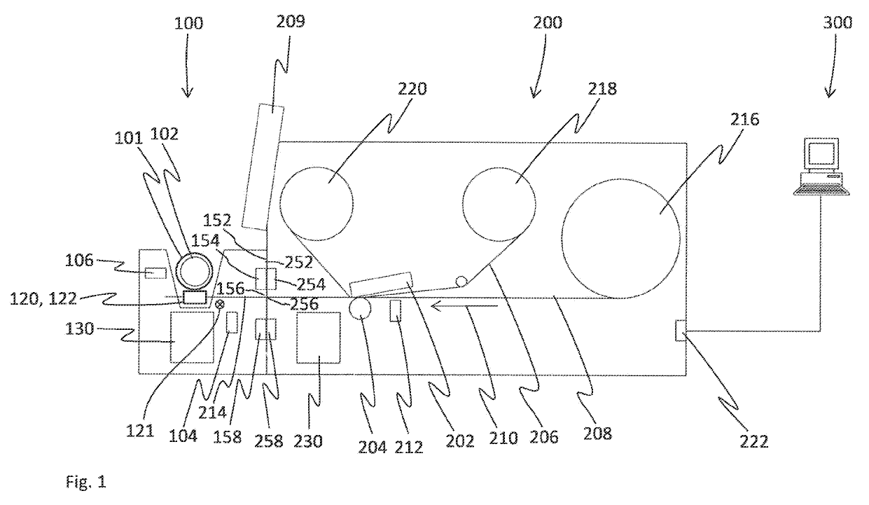

FIG. 1 shows an embodiment of a device generally designated by reference numeral 100 for providing a tube arranged or arrangeable in a closed circumferential manner around a prolate object 102, preferably around a conductor, as a marking 101 of the object 102.

The device 100 comprises a printer 200 configured to dispense a printed tube 214 in the longitudinal direction 210 or a material interface 156 configured to receive a printed tube 214 dispensed from a printer 200 in the longitudinal direction 210.

Furthermore, the device 100 comprises a cutting unit 120 configured to cut through the printed tube 214 at a cutting position of the tube in a transverse direction 121 transversely, preferably perpendicularly, to the longitudinal direction 210 of the tube, wherein at least at the cutting position an upper half of the tube and a lower half of the tube, at the end and/or at the inside, abut on each other or are connected to each other.

Furthermore, the device 100 comprises an opening unit 122 for opening the upper and lower halves of the tube. The opening unit 122 comprises at least two opening rollers, each rotatable about a rotational axis. The respective rotational axis is perpendicular or substantially perpendicular to the longitudinal direction 210 and to the transverse direction 121. The at least two opening rollers abut against the cut and printed tube, preferably on opposite sides in the transverse direction 121.

Embodiments may allow the tube to be cut and provided opened. The cutting unit 120 may also be referred to as a cutting device. For example, due to the combination of the cutting unit 120 and the opening unit 122, the length of the tube may be adjustable by the user of the device.

Optionally, the embodiment comprises a mechanical interface 152 configured to removably attach the device 100 to a printer 200. Alternatively or additionally, the device 100 comprises a data interface 158 configured to communicate with the printer 200 for providing (for example, applying) the printed, cut, and opened tube 101 as a marking.

For a concise description, and without limitation of the prolate object 102, a conductor is described below as an example of the prolate object 102.

Furthermore, embodiments of the variant of a device 100 detachably attached or attachable to the printer 200 are described or shown below. The features disclosed in the context of this embodiment are also disclosed for a further embodiment of each embodiment in which the device 100 and the printer 200 form a (for example, non-destructively separable) printing system (also: monolithic printing system). A data interface and an electrical interface may be implemented in the latter variant by means of a respective continuous line or plug-in connector.

At least one sensor 106 of the device 100 is configured to detect the conductor 102. Through a material interface 156, the device 100 receives the tube 214 output from the printer 200. The tube is printed and may still be closed, i.e., the upper and lower halves of the tube may be connected end-to-end or internally (for example, flat).

The cutting unit 120 and the opening unit 122 are examples of actuators of the device 100. At least one of the actuators 120 and 122 of the device 100 is configured to and/or controlled to provide, preferably arrange (i.e., apply) the marking 101 on the conductor 102 in response to detecting the printed tube (for example, by means of the sensor 104), communicating with the printer 200 (for example, via the data interface 158), and/or detecting the conductor 102 (for example, by means of the sensor 106) by means of the printed product 214 output from the printer 200.

Preferably, the device 100 further comprises an electrical interface 154 for supplying power to the device 100 via the printer 200. Alternatively or additionally, the device 100 may comprise its own power supply, such as a power supply for connection to a power grid or a rechargeable electrical energy storage device (such as a secondary cell).

Optionally, the device 100 comprises a control unit 130 or regulating unit 130 configured to control or regulate at least one or each actuator (for example, the actuator 120 and/or 122) of the device 100, for example, according to a controlled variable whose actual value is detected by the sensor 106 as measured values. Alternatively or additionally, the control unit 130 or the regulating unit 130 may be configured to detect the measured values of the at least one sensor 104 and/or 106 and send them to the printer via the data interface 158. Alternatively or additionally, the control unit 130 or the regulating unit 130 may be configured to receive control commands for controlling or regulating the at least one actuator (for example, the actuator 120 and/or 122) from the printer 200 via the data interface 158 and/or to send control commands for controlling or regulating the printer 200 to the printer 200 based on measured values of the at least one sensor 106.

The marking 101 is preferably the opened, cut and printed tube, which is also designated by the reference numeral 101. The printed product 214 may be a printed medium 208 printed by the printer 200. The print medium 208 comprises the tube. The tube may be a so-called continuous tube, for example, a size of a magazine of the tube may be independent of the function of the device. Alternatively or additionally, the tube may be a heat shrinkable tube.

The marking 101 may comprise a portion of the printed product 214, such as a portion of the printed product 214 cut by the device 100 using the cutting unit 120. The marking 101 may also be referred to as a label.

Applying the marking 101 to the conductor 102 may comprise a positively (for example, displaceable in the longitudinal direction of the conductor 102) connection of the marking 101 to the conductor 102. For this purpose, the tube 101 and/or a foil (for example, a weldable thermoplastic foil) that can be bonded to itself at the ends (preferably by the action of heat) may be comprised.

Optionally arranging or applying the marking 101 on the conductor 102 by means of one of the actuators, preferably by means of the opening unit 122, comprises opening the cut tube 214 and sliding the opened tube 101 onto the conductor 102 as a marking.

The device 100 may be configured to apply the marking 101 to the conductor 102 when the conductor 102 is already mounted (for example, when a distal end of the conductor is contacted or both ends of the conductor are contacted and/or one or both ends of the conductor are not free ends). Preferably, the conductor 102 will not be rotated about a transverse axis transverse to the longitudinal direction 210 of the conductor 102 and/or will not be rotated about a longitudinal axis parallel to the longitudinal axis of the conductor 102 and/or will be at rest during application.

The tube 101 applied to the conductor 102 may be captive. Alternatively or additionally, a printed surface of the applied tube 101 may be planar or substantially free of curvature. For example, the printed surface may be arranged between two embossments in the tube 101 that are parallel to the longitudinal direction. As a result, the printed surface may be easily readable and/or sufficiently large.

The marking 101 may be durable, for example, in terms of printing (preferably in that the printer 200 is a thermal transfer printer), in terms of the material of the printing medium 208 (for example, in that the tube comprises a thermoplastic as the printing medium 208), and/or in terms of attachment to the conductor 102 (for example, in that the marking 101 is positively, frictionally, and/or adhesively connected to the conductor 102).

The tube 101 as marking may be space-saving, for example so that a plurality of conductors 102, each carrying such marking 101, may be arranged in close proximity to one another. Alternatively or additionally, the marking 101 may be displaceable and/or rotatable, for example by positively connecting the marking 101 to the conductor 102. This may allow the marking 101 to be aligned on conductors 102 (such as cables) that are in close proximity to each other.

The first embodiment example of the device 100 shown in FIG. 1 is attached to an embodiment example of the printer generally designated by reference numeral 200. While the embodiment of the printer 200 shown in FIG. 1 is shown and described in connection with the first embodiment of the device 100, the other embodiments of the device 100 may also be attachable (preferably alternately) to the embodiment of the printer 200.

The embodiment of the printer 200 comprises a print head 202, a print roller 204, a light barrier 212 for detecting the printing medium 208 (i.e., the material to be printed), for example, for detecting control holes, (for example, black) control marks, a beginning and/or an end of the printing medium 208. The printing material 206 is, for example, a color ribbon.

The material 208 to be printed is guided between the print head 202 and the print roller 204, along with the color ribbon 206. The light barrier 212 may detect a beginning of the printing medium 208 during printing to ensure positioning of the printed image within the portion of the printed product 214 by means of which the marking 101 is formed.

The printer 200 comprises interfaces that are spatially associated with and/or functionally correspond to the interfaces of the device 100, respectively. The spatially assigned and/or functionally corresponding interfaces are connected or connectable to each other in pairs.

Preferably, the printer 200 comprises a mechanical interface 252 that is connected or connectable to or that is in communication with or can be brought in communication with the mechanical interface 152 of the device 100. Preferably, the spatial association implies that when the mechanical interface 152 and 252 are connected (e.g., interlocked), the other interfaces of the device 100 and the printer 200 are also respectively connected or interchangeable.

Alternatively or additionally, the printer 200 comprises a data interface 258, which is connected or connectable to the data interface 158 of the device 100 or which is, or can be brought, in communication (or exchange) with the data interface 158 of the device 100. Alternatively or additionally, the printer 200 comprises a material interface 256, which is connected or connectable to the material interface 156 of the device 100 or which is, or can be brought, in communication (or exchange) with the material interface 156 of the device 100.

For example, the material interfaces 156 and 256 are in connection or are interchangeable for exchanging the printed product 214. The data interfaces 158 and 258 are in connection for exchanging measurement data from the respective sensors 104, 106 and/or 212 and/or control commands from the control unit 130 of the device and/or from a control unit 230 of the printer 200.

Optionally, as shown by way of example in FIG. 1, the printer 200 comprises an interface 222 to a computer or computer network 300 (for example, a connection to the Internet). The printer 200 (for example, its control system 230) may receive print jobs via the interface 222.

The device 100 for providing the tube 101 as a marking, preferably for circumferentially arranging the tube 101 around the conductor 102 (i.e., applying the marking 101 to the conductor 102), is also referred to as an applicator.

An embodiment of the device 100 (for example, the aforementioned first embodiment of the device 100) or a printing system comprising an embodiment of the device 100 and an embodiment of the printer 200 (for example, the aforementioned embodiment of the printer 200) are configured to perform one or more of the following functions and method steps.

The device 100 and the printer 200 may perform operations (also referred to as actions), i.e., a set of one or plurality of process steps, alternately, particularly in providing the tube 101 or arranging the tube 101 (i.e., applying the marking 101 to the conductor 102). In doing so, the device 100 (or its control system 130) and the printer 200 (or its control system 230) communicate with each other via the data interfaces 158 and 258, respectively, for example to exchange or coordinate parameters (also: operation parameters), start, completion and/or timing of the operations (preferably of the next operation in each case). Alternately performing the operations may comprise interleaved operation of the device 100 and the printer 200.

In a first implementation, an overall sequence control is stored (e.g., implemented or executably stored) in the printer 200, for example, in the control unit 230 (preferably by means of firmware stored in the control unit 230). The overall sequence control may comprise printing on the printing medium 208 and applying the printed product 214 resulting from the printing.

A sequence control of the device 100 may be stored (e.g., implemented or executably stored) in the device 100 and/or the printer 200. The sequence control of the device 100 may comprise (preferably exclusively) providing or applying the marking 101 to the conductor 102 by means of the printed product 214. For example, the marking 101 is provided or arranged or applied to the conductor 102 by executing the sequence control of the device 100.

In other words, the execution of the sequence control of the device 100 may be executed partially or entirely in the device 100 or exclusively in the printer 200. In any case, execution of the sequence control of the device 100 causes the marking 101 to be provided or applied to the conductor by means of the device 100.

In a first variant of the first implementation, the sequence control of the device 100 is stored in the printer 200. The device 100 preferably does not have any sequence control, for example, it also does not have a control unit 130. The control unit 230 of the printer (for example, the firmware of the printer 200 in the control unit 230) is configured to (preferably individually) control (or drive) or (preferably individually) query (or detect) the actuators (for example, 120 and/or 122) and sensors (for example, 104 and/or 106) of the applicator 100 via the data interfaces 158 and 258.

In a second variation of the first implementation, the sequence control of the device 100 is stored (e.g., implemented or executably stored) in the device 100. For example, the device 100 comprises the control unit 130 or the regulating unit 130 in which the sequence control of the device 100 is stored (e.g., implemented or executably stored). Preferably, the control unit 130 or the regulating unit 130 is configured to control or regulate the providing or applying. For simplicity and without limitation, reference is made herein to the control unit 130, i.e., the function of a closed-loop control is optionally comprised.

Execution of the sequence control (preferably in the control unit 130) is started by the printer 200 (for example, the control unit 230, preferably by means of the printer firmware). For this purpose, the device 100 may receive a control command via the data interface 158 or may be energized via the electrical interface 154. As soon as an operation of the device 100 is required, the printer 200 (for example, the control unit 230, preferably by means of the printer firmware) outputs a signal as a control command to the device 100 via the data interface 258 or 158.

Preferably, the printer 200 waits while the device 100 performs the requested operation (for example, initiated by the control command). Once the device 100 sends (e.g., reports) a signal via the data interface 158 or 258 as a control command of completion of the operation, the printer 200 continues execution of the overall sequence control.

Optionally, the signal from the applicator 100 to the printer 200 indicates a status of completion of the operation. For example, the status may indicate successful completion or an error that occurred during execution of the operation.

In a second implementation, the device 100, for example the control unit 130 (preferably by means of firmware of the applicator 100) executes the overall sequence. In other words, the overall sequence control is stored (e.g., implemented or executably stored) in the device 100, for example, in the control unit 130 (preferably by means of firmware stored in the control unit 130). By executing the overall sequence control, the device 100 controls the overall sequence.

The printer 200 acts as a slave in the overall operation. For example, the printer 200 has sovereignty over the printed image, i.e., the printer 200 (preferably its control unit 230) performs the printing as an operation of the printer 200 in response to a corresponding control command from the device 100. Optionally, the printer 200 issues a control command (i.e., a first start command) to execute the overall sequence control, for example, because only the printer 200 knows about the content and/or the presence of a print job.

To implement the interleaved operation, the device 100 and the printer 200 exchange information (for example, measurement data and/or control commands) using the data interface 158 and 258, respectively.

The exchanged information may comprise measured values (for example, electrical voltages, electrical currents, electrical frequencies), preferably measured values of the sensor 104 and/or 106, which are transferred (i.e., sent) from the device 100 to the printer 200. Alternatively or additionally, measured values of a sensor of the printer 200 (for example, the light barrier 212) may be transferred (i.e., sent) from the printer 200 to the device 100. The device 100 or the printer 200 may determine (for example, calculate) sequence control parameters based on the measured values and/or transmit the measured values or the parameters to the computer or computer network 300 (for example, to application software) via the interface 222.

For example, the sensor 106 may detect a diameter or circumference of the conductor 102 (or the prolate object about its longitudinal axis). The control unit 130 and/or the control unit 230 may determine a length of a feed of the printing medium 208 and/or a selection of the printing medium 208, for example, depending on the detected diameter or circumference.

Furthermore, when a defined threshold value is exceeded, these measured values may be transferred as a digital signal (for example, either as a state “0” or a state “1”) to the data interface 158 or 258, respectively, in order to inform the other (printer 200 or device 100, respectively) when a defined state (for example, the completion of an operation). For example, reaching an end position or a reference point of an actuator (for example, actuator 120 and/or 122) may be indicated.

A reference move of an actuator of the applicator 100 (for example, the actuator 120 and/or 122) may serve to mechanically move the actuator (i.e., a drive connected to a mechanism of the applicator 100) to a determined position of the actuator (i.e., the mechanism), referred to as a reference position. A control command from the printer 200 or a process step of the operation, sequence control, and/or overall sequence control performed by the applicator 100 may comprise a motion (for example, a travel command) of the actuator, with the reference position serving as a reference point for the motions.

When the control unit 130 of the device 100 (for example, its applicator firmware) calculates one or more parameters of the provisioning or application (i.e., sequence control) from measured values (for example, transferred from the printer 200 or detected by the sensor 104 and/or 106), this or these may be transferred to the control unit 230 of the printer 200 (preferably to its printer firmware) in accordance with a communication protocol via the data interface 158 and 258. Furthermore, the control unit 130 of the device 100 (preferably its applicator firmware) may also use measurement data detected by the printer 200 (for example, measurement data of the light barrier 212) to control the sequence control of the device 100 (for example, as parameters of the provision or application).

The printer 200 may be configured to print normal labels, for example, when no device 100 is attached to the mechanical interface 152 and/or the data interface 158.

The printer 200 may be a thermal transfer printer. The thermal transfer printer may provide high contrast and consistent marking 101. For example, the printer 200 may be a thermal transfer roll printer.

The embodiment of the printer 200 comprises an unroller 216 (or source roller) of the printing medium 208 disposed upstream of the print head 202, an unroller 218 (or source roller) of the printing material 206 disposed upstream of the print head 202, and a rewinder 220 (or target roller) of the printing material 206 disposed downstream of the print head 202.

An electrical interface 254 of the printer 200 is configured to provide electrical power to the device 100 attached to the printer 200 via the electrical interface 154 thereof.

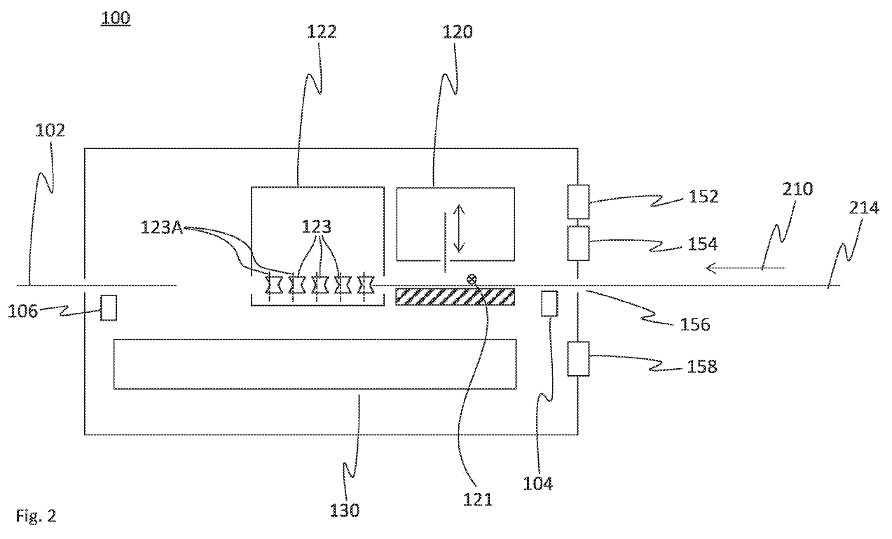

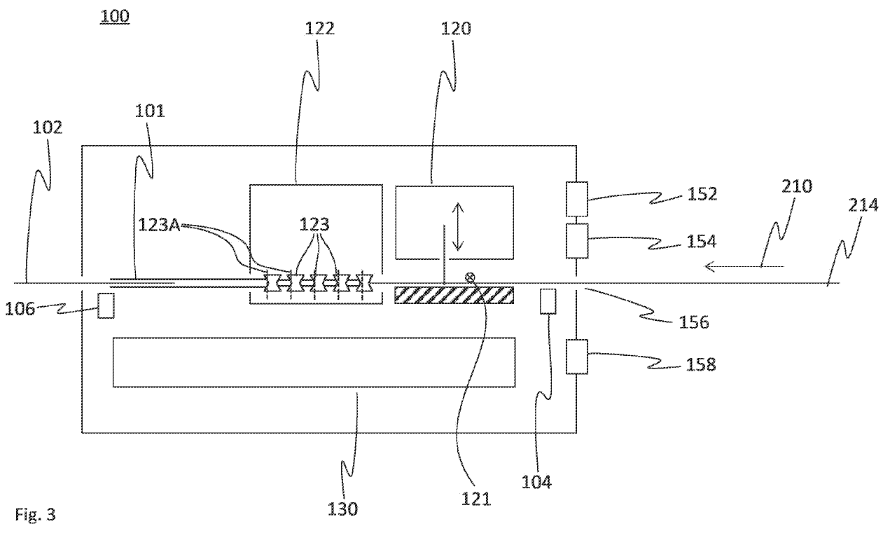

FIGS. 2 and 3 show a schematic sectional view of a second embodiment of the device 100 for providing a printed marking in a first state and a second state of providing (for example, applying), respectively.

The second embodiment of the device 100 may be implemented independently or as a further embodiment of the first embodiment of the device 100. Features of the first and second embodiments of the device 100, which are denoted by the same reference numerals, may be identical or interchangeable.

The second embodiment of the device 100 is configured to provide a tube (for example, a heat-shrinkable tube) as a printing medium 208 and/or a printed tube as a printed product 214 and/or an opened tube 101 as a marking and/or to push or attach it to the conductor 102. When the tube is printed and/or cut (for example, by means of the first actuator 120 of the device 100), the tube is pressed flat, whereby its cut end or at least a portion of the printed tube may be closed, i.e., the cut edge or the inner sides of the tube 214 (i.e., the upper and lower halves of the tube 214) adhere to each other.

The second actuator as opening unit 122 is configured to open the adhering cut edge of the printed tube and/or the adhering inner sides (i.e. the halves of the tube) of the printed tube 214. To this end, the opening unit 122 comprises (preferably waisted) rollers 123 that exert a force in pairs on opposite lateral edges of the printed tube 214 to open the cut edge of the tube and/or to release the inner sides of the tube from each other. In the schematic illustration of FIGS. 2 and 3, one of each pair of oppositely disposed rollers 123 is visible as the pairs are aligned perpendicular to the longitudinal direction or direction of movement 210.

In the second state shown in FIG. 3, the printed tube 214 is opened by means of the opening unit 122, provided as a marking 101 due to a feed (for example, the opening unit 122 and/or the printer 200) and/or arranged closed around the conductor 102 (for example, pushed onto the conductor 102), and cut off at the end by means of the cutting unit 120.

The rollers 123 are rotatable about rotational axes 123A perpendicular (for example vertical) to the longitudinal direction 210 and to the transverse direction 121, preferably driven to feed the printed tube 214.

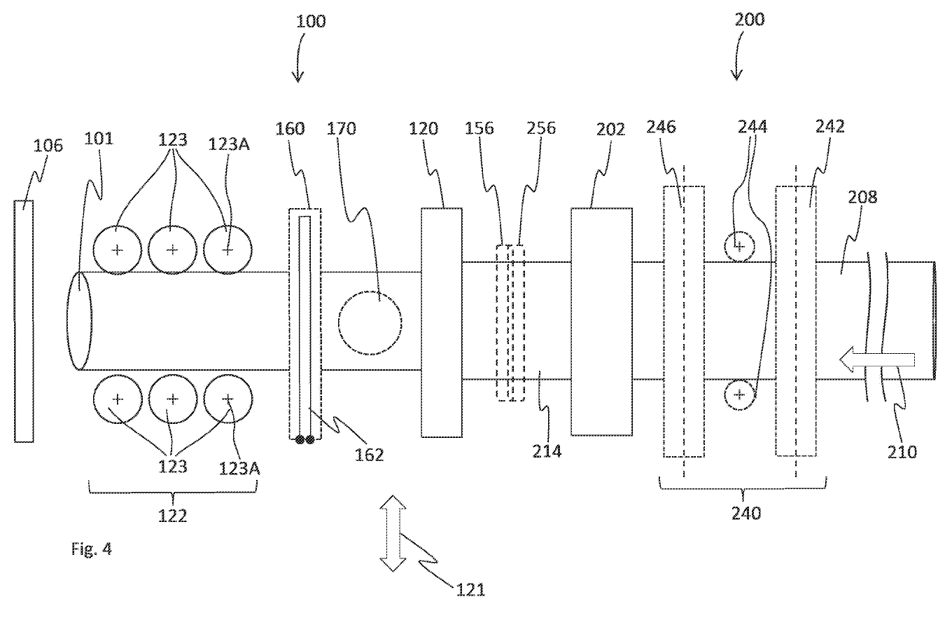

FIG. 4 shows a schematic top view of a third embodiment of the device 100 for providing a tube as a marking. The third embodiment of the device 100 may be implemented independently or in further embodiment of the first and/or second embodiment of the device 100. Features of the first, second and/or third embodiments of the device 100 designated by the same reference numerals may be the same or interchangeable.

The device 100 comprises a print head 202, or a material interface 156 for receiving a tube as a printed product 214 from a print head, a cutting unit 120, and an opening unit 122. The opening unit 122 may comprise a roller alley having rollers 123.

Optionally, a roller arrangement 240 (preferably an arrangement of roller pairs) is incorporated into the transport process. The roller arrangement 240 comprises at least two pairs of rollers, for example 2 or 3 pairs of rollers. A first pair of rollers 242 is arranged in the transverse direction 121 (for example, horizontally). A further (or in the longitudinal direction 210 farther) pair of rollers 242 is arranged perpendicular to the longitudinal direction 210 and perpendicular to the transverse direction 121 (for example vertically).

The roller arrangement 240 may be arranged in front of the flat holding device 160. An optional third pair of rollers 246 (counted in the longitudinal direction 210) of the roller arrangement 240 may be arranged in the transverse direction 121 (for example, horizontally).

The rotational axes of a pair of rollers are parallel to each other. The rollers of a pair of rollers are arranged to convey the printed tube 214, for example, appropriately spaced and/or force-loaded perpendicular to the respective rotational axis.

Optionally, the horizontal pair of rollers may form the compartment retaining unit 160. At least the pair of rollers with a vertical rotational axis may have rollers with a circumferential groove.

Preferably, the opening unit 122 or the holding-flat unit 160 is configured to expand the tube 124 by heating one side. For example, the holding-flat unit 160 comprises a heating element 162 (preferably a heating wire). The heating element 162 may be arranged in a stationary and/or longitudinally movable holding-down edge (for example, the holding-down edges 700 and/or 710 described below) in the holding-flat unit 160 or spaced therefrom. As a result of heating on one side, the tube 214 (for example, a heat shrink tube) contracts on one side and inevitably bulges out.

Optionally, air may be blown against the longitudinal direction onto or into a cut end of the tube 214 for opening the upper and lower halves of the tube. Alternatively or additionally, the opening unit 122 may comprise a needle wheel or wheels that penetrate the tube 214 to open and/or expand the tube 214 upon feed.

A detection of the tube 214 may be done optically, inductively or capacitively by means of the inserted conductor 101.

The opening rollers 123 are preferably movable in the transverse direction 121, for example the opening rollers 123 exert a predetermined and/or controlled force on the longitudinal edge of the printed tube 214.

Providing the opened, cut, and printed tube 101 (for example, including printing using the printer 200) may be controlled or initiated by a sensor 106. The sensor 106 may detect the presence of the conductor 102 (for example, in a non-contact manner). Alternatively or additionally, the sensor 106 may comprise a push button (also: operator button) that is actuated by a user as a control signal for provisioning (i.e., provisioning request). The control button may be positioned to be actuated by the hand holding the conductor 102.

The opening process may be assisted by pulling on the outer surfaces, i.e., the upper and lower halves of the tube. Optionally, the opening unit 122 or a vacuum opening unit 170 comprises two or at least two suction cups that are pressed onto the surface of the tube (for example, onto the upper and lower halves of the tube, respectively).

Alternatively or additionally, air may be injected against the conveying direction 210, i.e., terminally at the intersection (or cutting position) of the tube. In this case, the longitudinal edges (i.e., the outer edges) of the tube are fixed in the opening rollers 123 (for example, the pairs of rollers of the opening unit 122) and the tube must not protrude, or not protrude too far, from the opening unit 122 (i.e., the last of the pairs of rollers in the conveying direction 210).

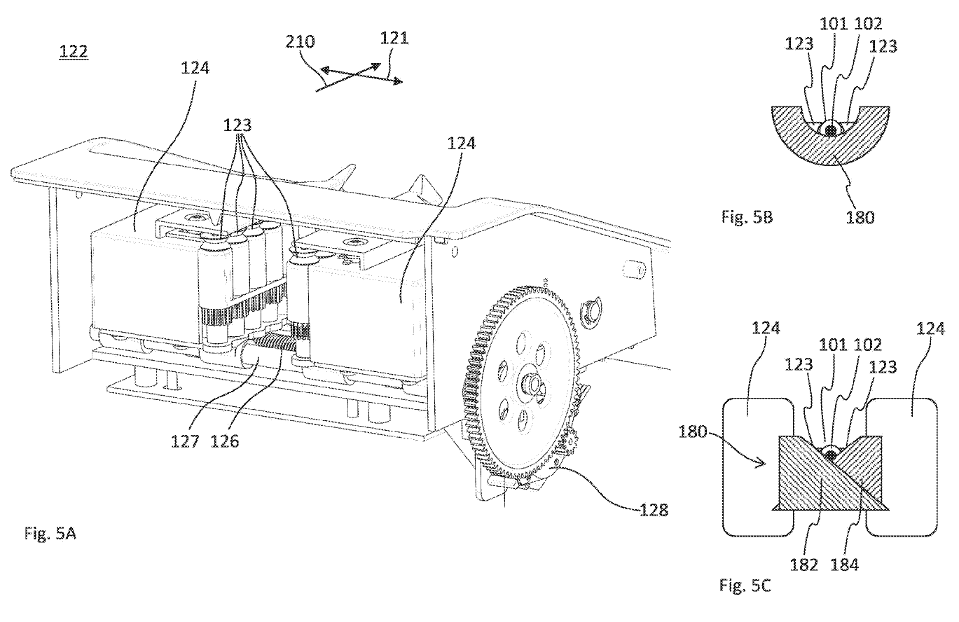

FIG. 5A shows a schematic perspective view of an exemplary opening unit 122 usable in embodiments of the device.

The opening unit 122 comprises opening rollers 123, which generate a flexing work by a bias in the transverse direction 121 towards the tube 214 and thereby open or pre-open the tube 214, which has been flattened (preferably by means of the holding-flat unit 160). The opening or pre-opening may be performed by a movement profile of the opening rollers 123. The movement profile may be part of the provisioning process. In this case, the opening rollers 123 are motor-driven to rotate (rotate) about rotational axes 123A. A synchronous rotation of the rollers 123 is implemented via gears or a belt drive.

The opening rollers 123 are preferably profiled, e.g. V-shaped or waisted.

Preferably, the tube 214 (for example, a heat shrink tube) is thus opened only from the outside.

The opening rollers 123 press the tube 214 open punctually from the outside. Alternatively or additionally, the tube 214 may be opened by line contact from the outside. The latter can be realized, for example, by belts around the opening rollers 123. The belts may be flat belts or (for example, like the opening rollers 123) may be profiled.

The opening unit 122 comprises carriages 124 movable in the transverse direction 121. For example, the carriages 124 are movable by means of a linear gear 126 driven by a drive 128 of the carriages 124. A transverse guide 127 of the carriages 124 may comprise sliding bearings.

The carriages 124 may assume at least one of the following positions or postures, for example controlled by the control unit 130 and/or 230: In a conveying position, the tube 214 may be moved forward and/or backward in the longitudinal direction 210 by rotating the rollers 123. In a flexing position, flexing of the tube 214 may be performed to open it. The fulling position and the conveying position of the carriages may coincide. In a release position, the carriages may move apart, for example to remove the opened tube 101.

The opening rollers 123 are positioned on movable carriages 124, which allow the tube 214 to be opened further. The carriages 124 may be motor-driven. The opening rollers 123 are positioned on movable carriages which enable them to adapt automatically to different tube sizes (width adjustment), for example depending on a width of the tube 214 measured by a width sensor.

The control system 130 and/or 230 may be configured to move the opening rollers 123 according to a motion profile. The motion profile is a combination of an advancing motion in the longitudinal direction 210 by rotation of the opening rollers 123 and a motion of the carriages 124 on which the opening rollers 123 are rotatably mounted. The one or more movement profiles may allow the tube 214 to be opened, pushed onto the conductor 102 (for example, provided arrangeable on the conductor 102), and/or removed from the applicator (for example, provided arrangeable).

The motion profile may be adjusted by (preferably using sensors 104, 106, and/or 212) measured (i.e., dynamically detected) material quantities, such as a width of the tube 214, during execution of the motion profile (i.e., dynamically).

The tube width may be obtained from print data (for example, from the printer 200 or the computer or computer network 300) and/or detected by a width sensor (for example, one of the sensors 104, 106, and/or 212). The width sensor may comprise a line sensor (for example, using a charge-coupled device or CCD) or a camera (for example, using a complementary metal-oxide semiconductor or CMOS).

The width sensor (for example, the line sensor) is arranged directly at the material interface 156 or 256 (i.e., the outlet of the printer 200) or between the holding-flat unit 160 and the opening unit 122 (i.e., upstream of the first pair of opening rollers in the feeding direction 210). The width sensor may also be used to control the motion profile.

The sensor 106 may be configured to detect that an object 102 to be marked (for example, the conductor, preferably a cable) is (or will be) inserted into the device 100 or is (or will be) inserted into the provided opened tube 101.

By means of the sensor 106, the movement profile may be controlled. For example, arranging (for example, threading) the provided opened tube 101 (i.e., a piece of tube) on the conductor 102 and/or releasing the tube 101 arranged on the conductor 102 by moving the opening rollers 123 laterally away from each other (i.e., by moving the carriages 124 apart in the transverse direction 121).

The sensor 106 may be movable in the feeding direction 210, for example, to allow the conductor 102 to be inserted or deployed (for example, in an application-specific and/or user-controlled manner) into the device 100 to varying degrees in opposition to the longitudinal direction 210, before initiating or continuing the motion profile in response to detecting the conductor 102 (as a control signal for deployment).

The sensor 106 may comprise a sensor for detecting the conductor 102. The sensor may detect the conductor 102 inductively, capacitively, optically, and/or tactilely. Alternatively or additionally, the sensor may implement at least one of the following sensing capabilities.

For a first sensing option, the sensor 106 is arranged between two adjacent pairs of rollers of the opening unit 160 (i.e., opening rollers 123 that abut or can be brought into abutment with the tube 214 at locations opposite in the transverse direction 121). The sensor 106 (for example, a capacitive or inductive sensor) measures whether a conductor 102 has been inserted. By using a plurality of sensors 106, the user may determine how far the conductor 102 should be inserted before triggering (i.e., initiating) the deployment (for example, the motion profile).

For a second sensing option, the sensor 106 (for example, a capacitive or inductive sensor) measures perpendicular to longitudinal direction 210 (preferably also perpendicular to transverse direction 121, for example, in a vertical direction) whether the conductor 102 has been inserted into the device 100 as an object to be marked.

Optionally, the sensor 106 may be movable in the longitudinal direction 210, which may allow the user to determine how far the conductor 102 should be inserted before initiating provisioning (for example, before triggering the motion profile).

For a third sensing option, alternatively or additionally, the width sensor (which is configured to measure the width of the tubing) may further detect the presence of the conductor 102. For example, the width sensor may detect the conductor 102 if the conductor 102 is to be fully inserted into the tube 101.

In one variation of each of the above sensor options, the sensor 106 comprises a light barrier (for detecting the conductor 102 in transmitted or reflected light, for example).

Optionally, the user (i.e., the operator of the device 100) may influence the provisioning (preferably the motion profile) through data input. The data input (for example, at a user interface of the device 100, a user interface of the printer 200, a user interface of the printing system, and/or via the computer or computer network 300) may comprise parameters of the provisioning (preferably the motion profile). The parameters may comprise an opening width (for example, of the opened tube 101) and/or an output position (for example, in the longitudinal direction 210) of the provided tube 101. For example, the parameters may be changed and/or stored in operation.

The parameters (also referred to as operation parameters) may be application-specific or article-specific. The operation parameters may be stored in the device 100, the printer 200, or the controlling software of the computer 300. The parameters may control provisioning (for example, the motion profile). The parameters may control or affect advancing or retracting the tube and/or flexing the tube. Alternatively or additionally, the parameters may determine whether to perform clamping or holding the tube flat and/or pre-opening.

In any embodiment, insertion of the conductor 102 may be aided by visual aids, such as reflective surfaces, a magnifying glass, and/or a camera (the image of which may be transmitted to the printer via the data interface 158 or 258, for example, and/or displayed on a display 209 of the printer 200). By means of reflective surfaces, a rear of the conductor 102 may be visible to the user.

In any embodiment, an object centering unit 180 (also: centering aid) may be provided for inserting or positioning the conductor 102. The object centering unit 180 may be arranged downstream of the opening unit 122 in the longitudinal direction 210.

FIG. 5B shows a schematic view of a first exemplary object centering unit 180 usable in embodiments of the device 100. The object centering unit 180 may comprise one or more plug-in templates each having a trough, an adjustable trough, and/or a wheel (rotatable about longitudinal direction 210) having a plurality of troughs.

Alternatively or additionally, a sleeve or collet may be pushed through the tube 101 to grip the conductor 102 and pull it through the tube 101.

FIG. 5C shows a schematic view of a second exemplary object centering unit 180 usable in embodiments of the device. The object centering unit comprises two movable prism halves 182 and 184, which preferably move together with the carriages 124. This assists in centering the conductor 102 so that it may be more easily inserted into the tube 101. Preferably, the two prism halves 182 and 184 each move with one of the carriages 124 (for example, are attached to the respective carriage 124). Scissors may be used as an alternative or additional means to the prism halves.

Optionally, in each embodiment of the device 100, there may be installed a unit configured to shrink, for example heat, the tube 101 at the end of deployment.

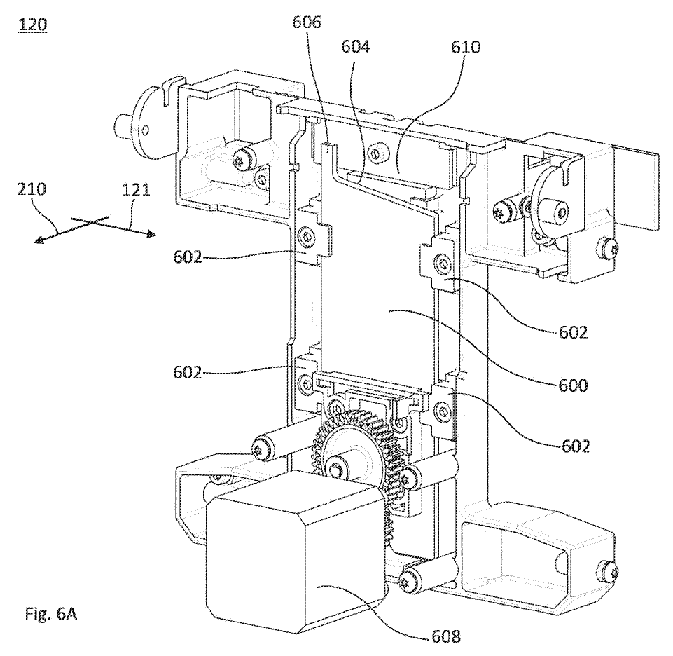

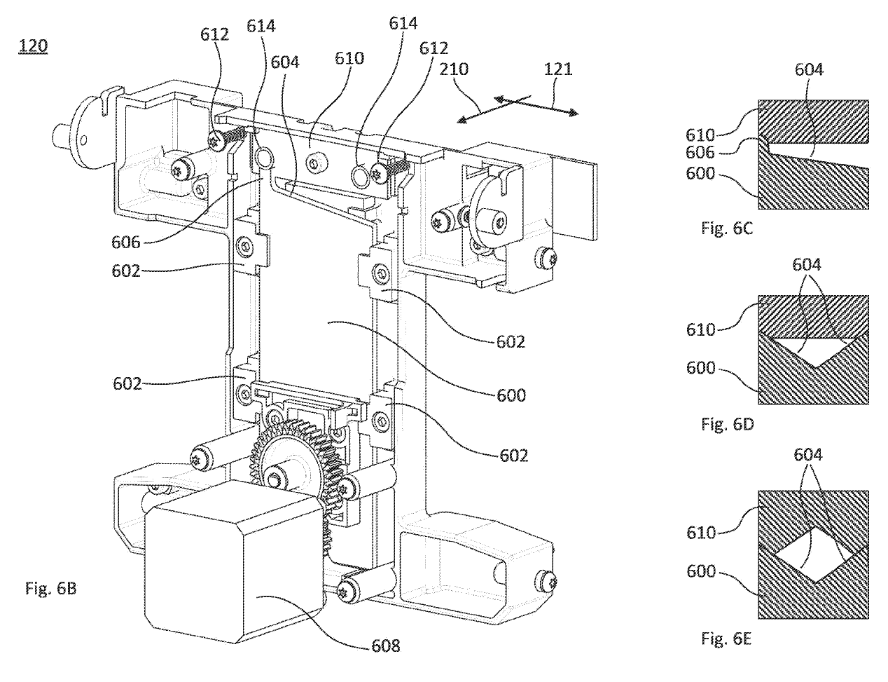

FIG. 6A shows a schematic perspective view of an example cutting unit 120 of the device 100 for providing the tube 101 as a marking. The cutting unit 120 may be an example actuator of the device 100 (for example, in addition to the opening unit 122).

The cutting unit 120 comprises a longitudinally movable blade 600 (also: knife), for example guided in at least two or four guides 602. The guides 602 may be arranged in pairs on longitudinal edges of the blade 600 opposite each other in the transverse direction 121.

The blade 600 is preferably longitudinally movable perpendicular to the longitudinal direction 210 and perpendicular to the transverse direction 121.

The longitudinally movable blade 600 comprises a cutting edge 604. The printed tube 214 is cut between the longitudinally movable blade 600 and a stationary blade 610 by shear forces. A cutting edge of the stationary blade 610 may be parallel to the transverse direction 121.

The cutting edge 604 of the longitudinally movable blade 600 may be parallel to the transverse direction 121 and/or parallel to the cutting edge of the stationary blade 610. In other words, the cutting edge 604 of the longitudinally movable blade 600 may be perpendicular to the cutting direction (i.e., the direction of movement of the longitudinally movable blade 600).

Alternatively, as shown schematically in FIG. 6A, for example, the cutting edge 604 of the longitudinally movable blade 600 may include an (preferably acute) angle with the transverse direction 121 and/or with the cutting edge of the stationary blade 610. In other words, the cutting edge 604 of the longitudinally movable blade 600 may be arranged at an angle to the transverse direction 121. The acute angle may be less than 60° or less than 45°. For example, the angle may be less than 30°, preferably between 5° and 10°. In one embodiment, alternatively or in addition to the cutting edge 604 of the longitudinally movable blade 600, the cutting edge of the stationary blade 610 is oblique to the transverse direction 121.

Preferably, the longitudinally movable blade 600 includes a guide pin 606 arranged to guide the longitudinally movable blade 600 past the stationary blade 610 without gaps and/or untilted or unwedged. In other words, the guide pin 606 is configured to prevent the longitudinally movable blade 600 from abutting the stationary blade 610 when the longitudinally movable blade 600 slides over the stationary blade 610 for cutting through the tube 214. Preferably, the guide pin 606 extends beyond the cutting edge 604 in the direction of movement of the longitudinally movable blade 600. In other words, the guide tang 606 is leading during cutting through.

A drive 608 of the longitudinally movable blade 600 is powered by the electrical interface 154 and/or controlled by the control system 130 and/or 230.

FIG. 6B shows examples of connecting means, for example to attach the holding-flat unit 160 to the cutting unit 120 of the device 100. For example, recesses are provided in the cutting unit 120 into which screws 612 project for attaching the holding-flat unit 160, optionally with spacer sleeves 614. By disassembling the connecting means 612 and 614, the blades 600 and 610 may be easily changed.

FIG. 6C shows a schematic view of a first exemplary combination of blades 600 and 610 that may be combinable with the example cutting unit 120. Preferably, a single-slanted embodiment (i.e., a combination of blades 600 and 610 in which one cutting edge is parallel to the transverse direction 121 and one is slanted) comprises a guide pin 604 to prevent the movable blade 600 from abutting on stationary blade 610 (also: counter holder).

FIG. 6D shows a schematic view of a second exemplary combination of blades 600 and 610, which may be combinable with the example cutting unit 120. The cutting edge 604 of the longitudinally movable blade 600 may be V-shaped. This may allow the tube 214 to be cut without slipping in the transverse direction 121 (also: centering functionality). Preferably, ends of the V-shaped cutting edge 604 in the open state (i.e. before cutting through) overlap with the cutting edge of the stationary blade 610. This may realize the functionality of the guide pin 604 and the centering functionality without additional components.

FIG. 6E shows a schematic view of a third exemplary combination of blades 600 and 610, which may be combinable with the example cutting unit 120. The blade shapes may be double-slanted. For example, the cutting edge 604 of the longitudinally movable blade 600 as well as the cutting edge of the stationary blade 610 may be V-shaped. The ends of the V-shaped cutting edges of the blades 600 and 610 may overlap in pairs in the open state (or open position).

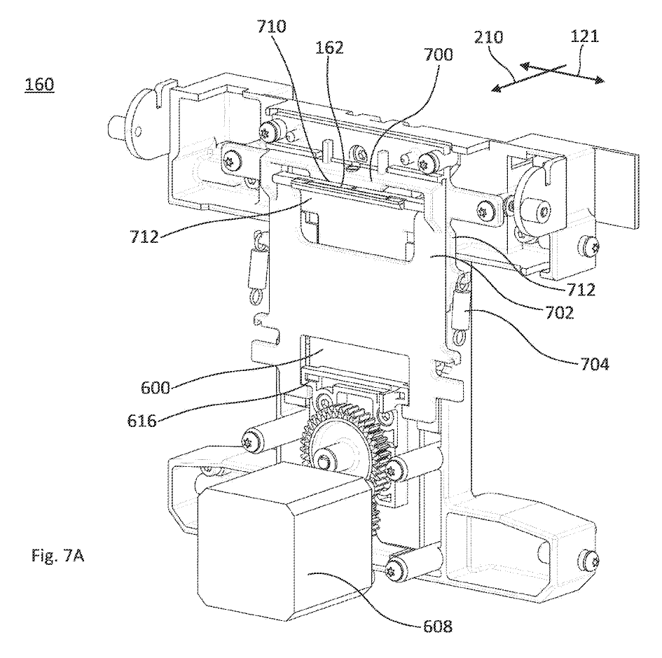

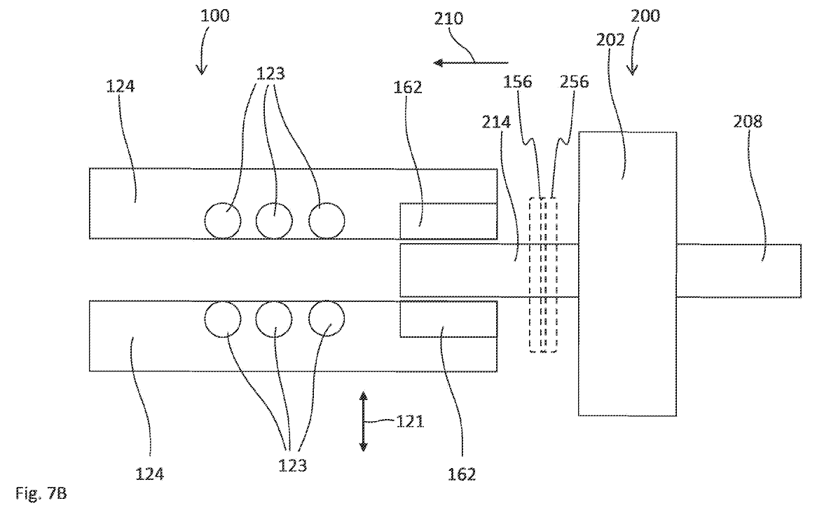

FIG. 7 shows a schematic perspective view of an example holding-flat unit 160 (also: holding-down unit or down holder) of the device 100. The holding-flat unit 160 may be an example of an actuator of the device 100 (for example, in addition to the actuator 120 and/or 122).

The holding-flat unit 160 is configured to selectively clamp the tube 214. The holding-flat unit 160 is preferably arranged close to the opening unit 160, for example arranged in the longitudinal direction 210 one or a few diameters of the tube 214 away from the opening unit 160. That is, when pressing on the longitudinal edges of the tube 214 by means of the opening rollers 123, the holding-flat unit 160 is not too far away so that the tube 214 (for example, on the input side of the opening unit 160) is kept flat or is pressed flat. The flat holding or flattening may be implemented by holding-down edges 700 and 710 each extending in the transverse direction 121, for example as shown schematically in FIG. 7A, or one roller (instead of one of the holding-down edges 700 and 710) or a pair of rollers (instead of both holding-down edges 700 and 710).

The holding-down edges may comprise a longitudinally movable holding-down edge 700 and a stationary holding-down edge 710. Preferably, the longitudinally movable hold-down edge 700 is longitudinally movable perpendicular to the longitudinal direction 210 (i.e., the feeding direction) of the tube 214 and perpendicular to the transverse direction 121.

Preferably, a longitudinally movable frame 702 comprises the longitudinally movable holding-down edge 700. Alternatively, or in combination, a stationary frame 712 comprises the stationary holding-down edge 710.

A resilient coupling 704 (for example, as shown in FIG. 7A, wherein the coupling 704 is unhooked) between the longitudinally movable holding-down edge 700 and the stationary holding-down edge 710 (for example, between the longitudinally movable frame 702 and the stationary frame 712) forcefully biases the longitudinally movable holding-down edge 700 toward an open position, i.e., to separate the holding-down edges 700 and 710.

Preferably, the drive 608 of the cutting unit 120 also drives the holding-flat unit. For example, the longitudinally movable blade 600 comprises a stop 616 arranged to move the longitudinally movable holding-down edge 700 (for example, the longitudinally movable frame 702) against the force of the resilient coupling 704 to a closed position in which the holding-down edges 700 and 710 hold the tube 214 flat. For example, after cutting through, the drive 608 may move the longitudinally movable blade 600 further out of a conveying plane of the tube 214 (i.e., move it away from the tube 214), with the stop 616 moving the longitudinally movable frame 702 to the closed position of the holding-flat unit 160.

When cutting through (which, with respect to providing a marking 101, precedes holding flat, for example), stop 616 and longitudinally movable frame 702 may be out of mesh.

FIG. 7B shows a schematic top view of an exemplary opening unit 122 of the device 100 for providing a tube as a marking. Alternatively or additionally to a heating element 162 in the holding-flat unit 160, heating elements 162 may be arranged in the carriages 124 of the opening unit 122. The optional heating element 162 of the holding-flat unit 160 preferably acts on the tube 214 perpendicular to the transverse direction to open the tube 214, for example from above or from below. The optional heating elements 162 of the opening unit 122 preferably act on opposite sides of the tube 214 in the transverse direction 121 to open the tube 214, for example horizontally from the side.

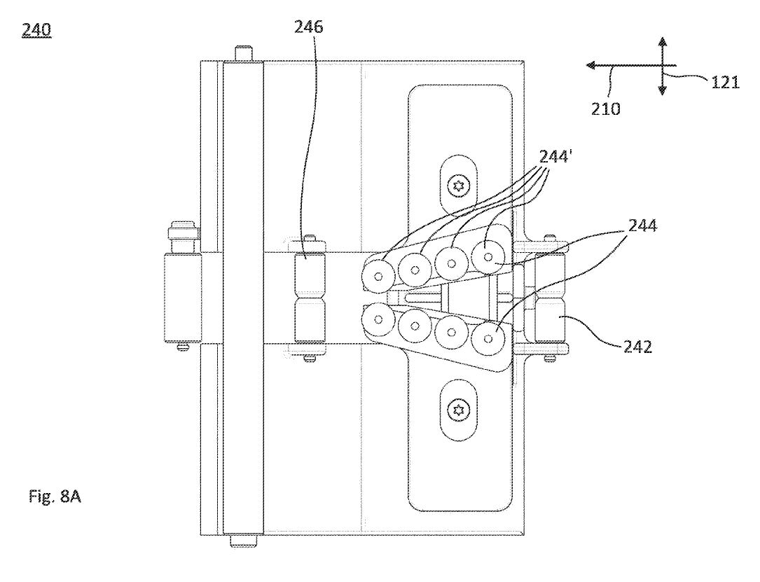

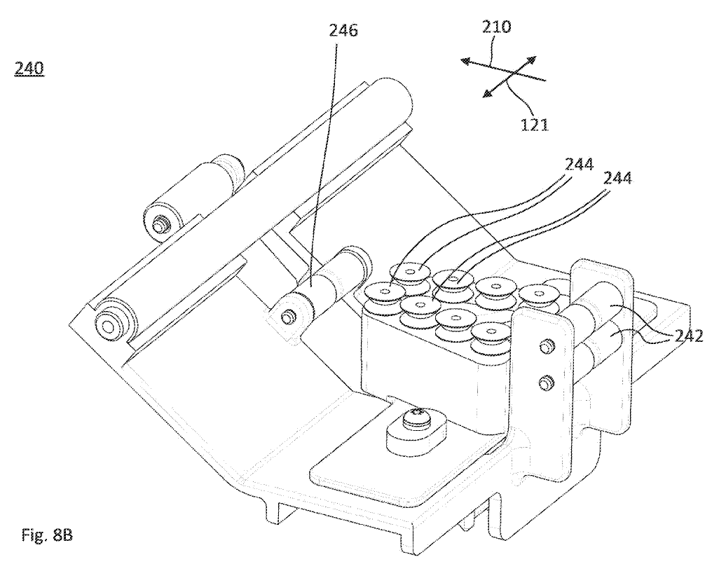

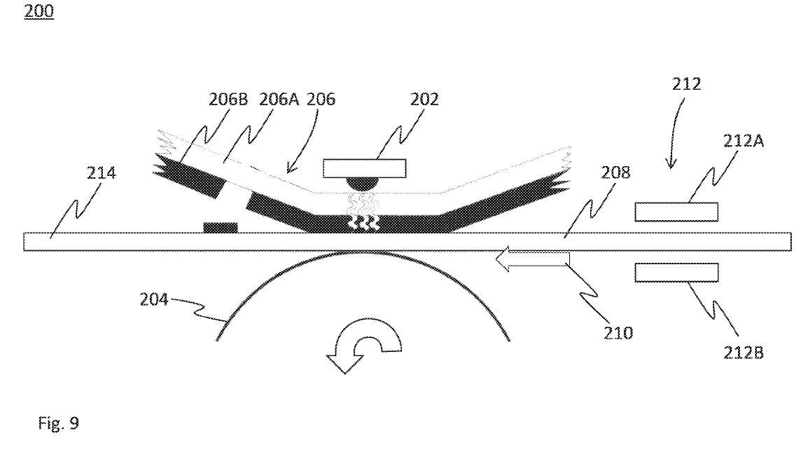

FIG. 8A shows a schematic top view of an exemplary roller pair arrangement 240 (or arrangement 240 of the pairs of rollers) of the printer 200 and/or the device 100 for providing a tube for marking. FIG. 8B shows a schematic perspective view of the exemplary roller pair arrangement of FIG. 8A.

Optionally, the arrangement 240 of the pair of rollers, or at least one of the horizontal pairs of rollers 242 and 246, may be part of the device 100 as the holding-flat unit 160. Alternatively or additionally, the arrangement 240 of the pair of rollers may be part of the printer 200, for example as shown in FIG. 4. The rollers of each or individual pairs of rollers may each have a circumferential groove or waist.

Distances between the rollers of each of a plurality of pairs of rollers 244 may decrease in the longitudinal direction, as shown schematically based on the rollers 244' (V arrangement).

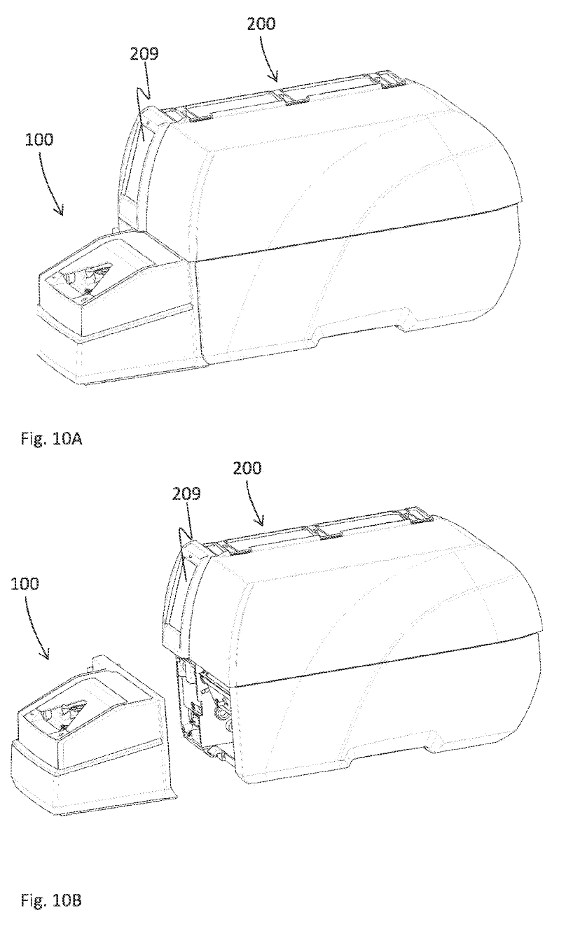

FIG. 9 shows a further embodiment of the printer 200, which may be implemented independently or as a further development of the embodiment of the printer 200 described in the context of FIG. 1. Features of the embodiments designated by the same reference numerals may be identical or interchangeable. The further embodiment of the printer 200 is an example of a thermal transfer roll printer.

A control unit 230 of the printer 200 controls a feed and/or a retraction of the printing medium 208 at the print head 202 and/or of the print product 214 at the material interface 256 (and consequently at the material interface 156 of the device 100) depending on the signals of the light barrier 212 and/or control commands obtained from the device 100 via the data interface 258 (i.e., via the data interface 158 of the device 100). For this purpose, the control unit 230 may control a drive (for example, a stepper motor) for rotating the print roller 204.

The light barrier 212 may be arranged in front of the print head 202 and/or the print roller 204 with respect to a direction of movement 210 of the printing medium 208 during feed. The light barrier 212 may comprise, as exemplarily shown in FIG. 6A, a light source 212A on the side of the print head 202 and a light sensor 212B on the side of the print roller 204. In a first variation, the positions of light source 212A and light sensor 212B may be interchanged. In a second variation, light source 212A and light sensor 212B may be arranged on the same side for detecting the printing medium 208 in reflection.

The print head 202 comprises a plurality of heating elements. When the heating elements are heated (for example, energized) and the print roller 204 applies a predetermined (for example, sufficiently large) pressure to the printing medium 208, the color pigments are transferred from the printing material 206 (for example, a color ribbon) to the medium to be printed. The control unit 230 may control the stepper motor to rotate the print roller 204 and control the energization of the heating elements of the print head 202.

The printing material 206 may comprise a plurality of layers. For example, the printing material 206 may comprise a carrier material 206A (for example, a carrier film) facing away from the printing medium 208 and a color layer 206B (for example, a color wax) facing toward the printing medium 208.

The printer 200 is preferably a tabletop device to which the device 100 may be attached as an interchangeable module, for example, specific to an application or for the duration of a unified application operation.

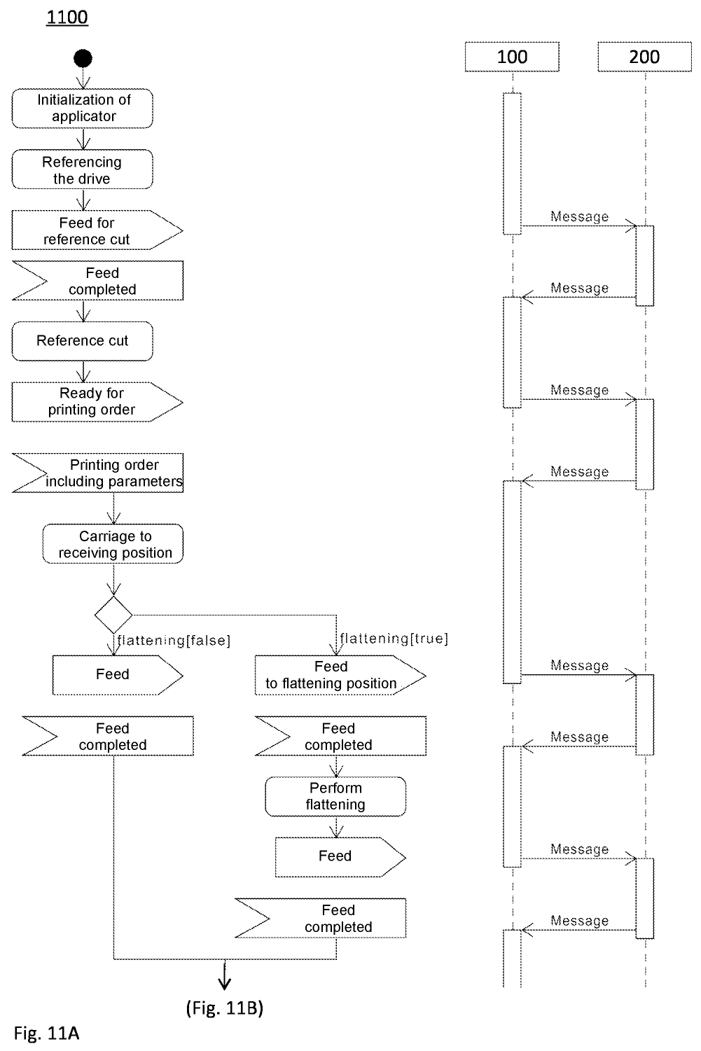

FIG. 10A shows a schematic perspective view of an exemplary printing system comprising an embodiment of the printer 200 and an embodiment of the device 100 for providing a tube as a marking 101, in a mounted position. FIG. 10B shows a schematic perspective view of the exemplary printing system of FIG. 10A in a disassembled position.

Each embodiment of the device 100 may be used by the following operating steps B1 to B17 and/or perform the following steps.

B1: The operator generates the print data on a PC 300 or a mobile device 300, for example a tablet computer or cell phone. Here, the printing material is already selected and the tube size and/or tube type are taken into account accordingly.

B2: The operator mounts the device 100 on the printer 200.

B3: The operator loads the print material into the printer 200, guides the printing medium 208 between the print head 202 and the ribbon 206, adjusts the material guide and optionally other adjustments, and closes the print head 202.

B4: The operator switches on the printer 200.

B5: The printer 200 (for example, the control system 230) recognizes the device 100 (for example, as an applicator) via the data interfaces 158 or 258, and initializes the printer 200 and the device 100.

B6: The operator sends a print job to the printer 200 via the print function of a computer 300 (for example, a personal computer) or a mobile device 300 (for example, a device 300 in data communication with the printer 200 via a wireless network or a cellular network).

B7: The printer 200 detects the beginning of the printing medium (or printing material) 208 via the light barrier 212 or alternatively performs a reference cut (for example, by means of the cutting unit 120 of the device 100 or another cutting unit of the printer 200). The reference cut may produce a piece of tubing of a manually removable length.

B8: The printer 200 prints a first section or piece of tubing 214.

B9: The printer 200 transports the piece of tube 214 (through the material interfaces 156 or 256) to the cutting position of the tube or to the cutting position of the cutting unit 120.

B10: The device 100 (for example, controlled by the control system 130) cuts the tube 214.

B11: The device 100 (for example controlled by the control system 130) takes over the cut and printed piece of tubing by means of the opening rollers 123.

B12: Meanwhile, the printer 200 pulls the printing medium 208 back (for example, while it is being supplied by the device 100) to the print start of the next piece of tubing.

B13: The device 100 travels a certain movement profile, for example depending on the material 208. The providing (for example, the motion profile) may comprise a lateral stroke, keeping the tube flat by means of the holding-flat unit 160, pushing the opening rollers by moving the carriages 124 in the transverse direction 121, flexing the tube by rotating the opening rollers 123, for example, with back and forth movement of the tube in the longitudinal direction 210, pre-opening the tube in the clamped or flat-held state, pre-opening by means of a suction cup, and/or pre-opening by means of the heating element 162.

B14: The device 100 provides the opened tube 101 for arranging (for example, threading) the tube 101 onto the object 102 (for example, a carrier, preferably a conductor, such as a cable).

B15. The user acknowledges (for example, using the push button as a sensor 106) that the object 102 is positioned (for example, inserted into the device 100), and/or the device 100 detects the presence of the object 102 using the sensor 106.

B16: The device 100 releases the arrangeable tube 101 or transports the tube 101 (i.e., piece of tubing) toward the inserted conductor 102, for example, for threading the conductor 102 in the tube 101.

B 17: The next print job may be started.

In the case of one or more print jobs (for the provision of a tube 101 or with a plurality of tubes 101), an interleaved sequence preferably occurs between device 100 and printer 200. In the case of a print job for a plurality of tubes 101, an interleaved sequence preferably occurs between device 100 and printer 200 so that the next tube 214, after the previous tube 101 has been cut and the printing medium 208 has been withdrawn, may be immediately printed and fed to device 100.

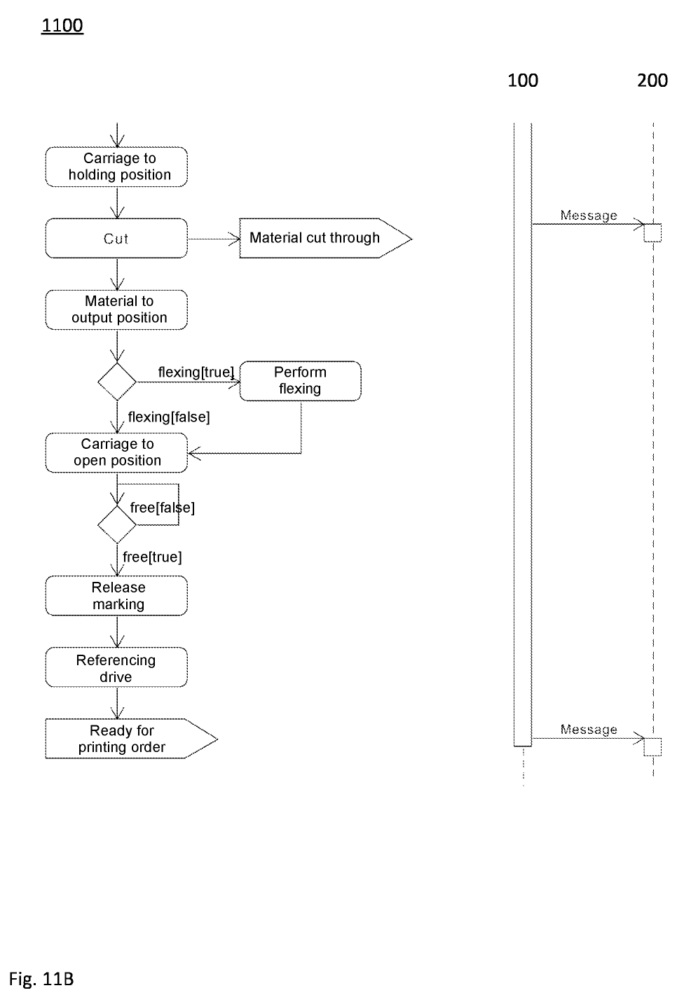

FIGS. 11A and 11B show first and second sections, respectively, of a flowchart of an embodiment of a method 1100 for providing a tube as a marking 101. The method 1100 may be implemented as a sequence control in the control system 130 of the device 100 and/or the control system 230 of the printer 200. In each case, the right-hand side shows corresponding actions as vertical bars and corresponding communications as horizontal arrows. Here, the “message” may comprise a control command. The “flattening” may refer to holding flat.

A method 1100 performed by the device 100, preferably by the control system 130, may comprise at least one of the following steps S1 to S24.

S1: The device 100, which may also be referred to as a sleeve opener, is initialized, such as turned on and/or mounted on a printer 200.

S2: At least one or each of the actuators (for example, drives and/or motors) of the device 100 is referenced, for example, performs a homing operation.

S3: A control command to execute a feed of the printing medium 208 by the printer 200 (for a reference cut) is sent to the printer 200, preferably via the data interface 158.

S4: A signal (for example, as a control command) to complete the feed is received by the printer 200, preferably via the data interface 158.

S5: The reference cut is performed, preferably by means of the cutting unit 120.

S6: A signal (for example as a control command) for readiness for a print job and/or for readiness for a provision of a marking 101 is sent to the printer 200, preferably via the data interface 158.

S7: A control command to execute a print job and/or to provide the marking 101 is received by the printer 200, preferably via the data interface 158. The received control command may comprise at least one parameter of the print job and/or the providing.

S8: At least one or each of the actuators (for example, drives and/or motors) of the device 100, preferably the longitudinally movable blade 600 and/or the holding-flat unit 160 and/or the carriages 124 of the opening unit 122, is moved to an open position for receiving a printed tube 214.

If a flat hold is not set (for example as a parameter), steps S9 and S10 are executed.

S9: A control command to execute a feed of the printing medium 208 by the printer 200 (for a cutting of the tube 214) is sent to the printer 200, preferably via the data interface 158.

S10: A signal (for example, as a control command) to complete the feed (for cutting) is received from the printer 200, preferably via the data interface 158.

If a flat hold is set (for example as a parameter), steps S11 and S15 are executed.

S 11: A control command to execute a feed of the printing medium 208 by the printer 200 (for holding the tube 214 flat) is sent to the printer 200, preferably via the data interface 158.

S12: A signal (for example, as a control command) to complete the feed (for holding flat) is received from the printer 200, preferably via the data interface 158.

S13: Holding-flat is performed, preferably by means of the holding-flat unit 160.

S14: A control command to execute a feed (for example, a differential feed between the flat holding position and the cutting position) of the printing medium 208 by the printer 200 (for a cutting of the tube 214) is sent to the printer 200, preferably via the data interface 158.

S15: A signal (for example, as a control command) to complete the feed (for cutting) is received from the printer 200, preferably via the data interface 158.

S16: At least one or each of the actuators (for example, drives and/or motors) of the device 100, preferably the longitudinally movable blade 600 and/or the holding-flat unit 160 and/or the carriages 124 of the opening unit 122, is moved to a holding position for holding the printed tube 214, preferably by means of the holding-down edges 700 and 710.

S17: Cutting of the printed tube 214 is performed, preferably by means of the cutting unit 120.

S18: A signal (for example, as a control command) to complete the cut is sent to the printer 200, preferably via the data interface 158.

S19: The cut and printed tube 214 is conveyed to an output position, preferably by means of the opening unit 122.

If flexing is set (for example as a parameter), step S20 is executed.

S20: A flexing of the cut and printed tube 214 is performed, for example by means of the opening unit 122.

S21: At least one or each of the actuators (for example, drives and/or motors) of the device 100, preferably the longitudinally movable blade 600 and/or the holding-flat unit 160 and/or the carriages 124 of the opening unit 122, is moved to an open position (for example, by spatially separating the holding-down edges 700 and 710).

If a release is set (for example as a parameter), step S22 is executed.

S22: At least one or each of the actuators (for example, drives and/or motors) of the device 100, preferably the carriages 124 and/or the opening unit 122, is moved to a release position (for example, by spatially separating the carriages 124).

S23: At least one or each of the actuators (for example, drives and/or motors) of the device 100 is referenced, for example, performs a homing operation.

S24: A signal (for example as a control command) for readiness for a print job and/or for readiness for a provision of a marking 101 is sent to the printer 200, preferably via the data interface 158.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference numerals
Device for providing a marking, for example applicator or printing system 100
Opened and printed tube (or sleeve) as marking 101
Prolate object, preferably conductor, for example copper conductors or optical fibers 102
Printing signal interface of a control signal for output of the printed tube, for example sensor for detecting the printed tube 104
Sensor of a control signal for provisioning the marking, for example sensor for detecting the object or a provisioning request 106
Cutting unit of the device 120
Transverse direction 121
Opening unit of the device 122
Opening roller, preferably waisted roller, of the opening unit 123
Rotational axis of the opening roller 123A
Carriage of the opening unit 124
Linear gear of the carriages 126
Transverse guide of the carriages 127
Drive of the carriages 128
Control unit or regulating unit of the device 130
Mechanical interface of the device 152
Electrical interface of the device 154
Material interface of the device 156
Printing signal interface of a control signal for output of the printed tube, for example data interface of the device 158
Holding-flat unit 160
Heating element, preferably in holding-flat unit or opening unit 162
Reduced pressure opening unit 170
Object centering unit 180
First prism half of object centering 182
Second prism half of object centering 184
Printer, for example thermal transfer printer 200
Print head of the printer 202
Print roller of the printer 204
Printing material, for example ribbon 206
Carrier material of the printing material, for example carrier foil 206A
Color layer of the printing material, for example color wax 206B
Printing medium of the printer (also: label material) 208
Display, preferably user interface, of the printer 209
Feeding direction or longitudinal direction of the print medium 210
Printer light barrier 212
Light barrier light source 212A
Light barrier light sensor 212B
Printed tube as print product of the printer 214
Unroller of the printing medium 216
Unroller of the printing material 218
Rewinder of the printing material 220
Data interface of the printer 222
Printer control unit 230
Roller arrangement 240
First pair of rollers, preferably horizontal pair of rollers 242
Second pair of rollers, preferably vertical 244
Third pair of rollers, preferably horizontal pair of rollers 246
Mechanical interface of the printer 252
Electrical interface of the printer 254
Material interface of the printer 256
Data interface of the printer 258
Computer or computer network 300
Motion blade 600
Guiding the moving blade 602
Cutting edge of the moving blade 604
Guide pin of the moving blade 606
Drive cutting unit and/or the holding-flat unit, for example the moving blade 608
Stationary blade 610
Screw for fastening the holding-flat unit 612
Spacer sleeve for mounting the flat retaining unit 614
Stop for holding-flat unit 616
Longitudinally movable hold-down edge 700
Longitudinally movable frame of the hold-down edge 702
Resilient coupling between hold-down edges 704
Stationary holding-down edge 710
Stationary frame of the hold-down edge 712

1. A device for providing a tube arranged or arrangeable in a circumferentially closed manner around a prolate object, as a marking of the object, the device comprising:
a printer configured to output a printed tube in a longitudinal direction or a material interface configured to receive a printed tube output from a printer in the longitudinal direction;
a cutting unit configured to cut through the printed tube at a cutting position of the tube in a transverse direction transverse, to the longitudinal direction of the tube, wherein at least at the cutting position an upper half of the tube and a lower half of the tube, at an end and/or on an inside, abut each other or are connected to each other; and
an opening unit configured to open upper and lower halves of the tube, the opening unitcomprising at least two opening rollers each rotatable about a rotational axis, a respective rotational axis being perpendicular or substantially perpendicular to the longitudinal direction and to the transverse direction,
wherein the at least two opening rollers abut against the cut and printed tube on opposite sides in the transverse direction or each is configured to drive a belt abutting against the cut and printed tube on opposite sides in the transverse direction.

2. The device of claim 1, wherein the opening rollers abut against the cut and printed tube in pairs at locations that are opposite to each other in a direction perpendicular to the longitudinal direction.

3. The device (100) of claim 1, further comprising:
an object centering unit configured to arrange the prolate object in alignment or coaxially with the cut and printed tube.

4. The device of claim 1, wherein the opening rollers are configured to push the cut and printed tube along the longitudinal direction over the prolate object for circumferentially closed arrangement around the prolate object.

5. The device of claim 1, further comprising:
a printing signal interface configured to capture a control signal related to the outputting of the printed tube; and/or
at least one sensor configured to capture a control signal related to the providing of the marking.

6. The device of claim 1, further comprising:
a roller drive configured to synchronously rotate the opening rollers about the respective rotational axis,
wherein the opening rollers adjacent to the cut and printed tube on opposite sides in the transverse direction are configured to rotate in opposite directions.

7. The device of claim 5, wherein the roller drive is configured to arrange the marking on the object in a circumferentially closed manner or to provide the marking for circumferentially closed arrangement, depending on the control signal for outputting the printed tube and/or the control signal for providing the marking.

8. The device of claim 1, further comprising:
two carriages longitudinally movable in the transverse direction,
wherein on each of the two carriages at least one of the at least two opening rollers is mounted rotatably about the respective rotational axis, and
wherein a distance between the two opening rollers of the respective pair of rollers and/or a pressing force of the opening rollers on the cut and printed tube depends on a captured or measured width of the tube.

9. The device of claim 8, further comprising: a width sensor disposed between a holding-flat unit and the opening unit or between pairs of rollers of the opening unit, the width sensor being configured to measure a width of the tube prior to the opening and/or during the opening.

10. The device of claim 1, further comprising:
a holding-flat unit configured to prevent buckling of the tube in a direction perpendicular to the longitudinal direction and/or in a direction perpendicular to the transverse direction.

11. The device of claim 10, wherein the holding-flat unit and the cutting unit are driven by a common drive.

12. The device of claim 10, wherein the holding-flat unit or an additional unit between the holding-flat unit and the opening unitcomprises a heating element configured to heat the tube on one side.

13. The device of claim 10, wherein the opening unit or an additional unit between the holding-flat unit and the opening unitcomprises two heating elements configured to press on the tube and/or conduct heat to opposite sides of the tube in the transverse direction.

14. The device of claim 1, further comprising:
a reduced pressure opening unit comprising at least one suction cup, each of which is configured to be brought into contact with the upper half of the tube and/or the lower half of the tube, respectively, and each of which is configured to separate the upper half of the tube and the lower half of the tube at least partially from each other by a reduced pressure in the respective suction cup for opening the tube.

15. A system for providing a tube arranged or arrangeable in a circumferentially closed manner around a prolate object, as a marking of the object, comprising:
a printer configured to output a printed tube as a printed product; and
the device of claim 1, wherein the material interface is arranged, relative to the printer, to receive the printed tube output from the printer as a printed product.

16. A method of providing a tube arranged or arrangeable in a circumferentially closed manner around a prolate object, as a marking of the object, comprising:
printing on a tube in a longitudinal direction or receiving a printed tube output at a material interface from a printer in a longitudinal direction;
cutting through the printed tube at a cutting position of the tube in a transverse direction transversely to the longitudinal direction of the tube by a cutting unit, at least at the cutting position an upper half of the tube and a lower half of the tube , at an end and/or on an inside, abut each other or are connected to each other; and
opening the upper and lower halves of the tube by an opening unit, wherein at least two opening rollers, each rotatable about a rotational axis, flexing the tube,
wherein a respective rotational axis is perpendicular or substantially perpendicular to the longitudinal direction and the transverse direction, and
wherein the at least two opening rollers abut against the cut and printed tube on opposite sides in the transverse direction or each drives a belt abutting against the cut and printed tube on opposite sides in the transverse direction.

17. The device of claim 1, wherein the prolate object comprises a conductor.

18. The device of claim 1, wherein the cutting unit is configured to cut through the printed tube at the cutting position of the tube in a transverse direction perpendicular to the longitudinal direction of the tube.

19. The device of claim 12, wherein the heating element is configured to heat the tube on an upper half of the tube or the lower half of the tube, for local deformation of the tube comprising local contraction of the tube.

20. The device of claim 14, wherein the at least one suction cup comprises at least two suction cups.
